(19) United States
(12) Patent Application Publication
(10) Pub. No.: US 2007/0082727 A1
(43) Pub. Date: Apr. 12, 2007

(54) Gaming machine

(75) Inventors: Masaki Ebisawa, Tokyo (JP); Tomoki Nakayama, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/371,163

(22) Filed: Mar. 9, 2006

(30) Foreign Application Priority Data
Oct. 7, 2005 (JP) 2005-295548

(51) Int. Cl. A63F 13/00

(52) U.S. Cl. 463/20

(57) ABSTRACT

According to a gaming machine of the present invention, when a specified internal win is determined based on a predetermined internal lottery table, an internal win is determined based on a specified internal lottery table having larger range of the random number determining the internal win of a replay than that of the predetermined internal lottery table. In addition, the internal win of the replay has higher priority than that of the specified internal win when the rotation of reel makes a stop.

### CROSS REFERENCE TO RELATED APPLICATION

This application is based upon and claims the benefit of priority from the prior Japanese Patent Application No. 2005-295548, filed on Oct. 7, 2005, the entire contents of which are incorporated herein by reference.

### BACKGROUND OF THE INVENTION

1. Field of the Invention

The present invention relates to a gaming machine.

2. Description of Related Art

It has been conventionally known a gaming machine, so-called, pachi-slot machine having reels, each of which having symbols arranged on a periphery thereof; display windows mounted to correspond to each of the reels and displaying some of the symbols arranged on the periphery of each reel so as to allow a player to see them; a start switch for outputting a signal requesting start of rotation of each reel, based on an operation by the player (hereinafter, referred to as “start operation”), on condition that a medal has been inserted; a stop switch for outputting a signal requesting stop of the rotation of the reel, correspondingly to types of the reels, based on a stop operation by the player; and a control unit for controlling an operation of a stepping motor to rotate and stop the respective reels, based on the signals outputted from the start switch and the stop switch. Generally in the pachi-slot machine, when all the reels are stopped, it is determined whether a win is achieved on the basis of a combination of symbols displayed by the display windows, and a medal is paid out based on the determination result.

At present time, in the pachi-slot machine forming the mainstream, if the start operation is carried out, an internal lottery is performed and an operation of stopping the reel rotation is carried out, based on a result of the lottery and the timing of the stop operation. Accordingly, even though a result relating to a win is determined by the internal lottery (hereinafter, a type of the internal lottery result will be referred to as “intemal win”), if the stop operation is not carried out at an appropriate timing, a combination of the symbols according to a win is not displayed. Accordingly, it is necessary for a player to have a skill, i.e., so-called observation push.

In such gaming machine, it is an object to provide a bonus game and to maintain player's expectation if relatively many medals have been paid out, whereby in general, if it is determined an internal win of a bonus game, it is done to memorize the internal win of the bonus game until a combination of the corresponding symbols is displayed, i.e., to perform a carryover. In such gaming machine, when the internal win of the bonus game is determined, even if the corresponding symbol combination is not displayed during a determined unit game (e.g., during one unit game which is performed after a start operation is detected until whether a win is made or not is determined), may be displayed at the unit game after next game to that unit game.

In such gaming machine, a player's interest is focused on which type the determined internal win belongs to. Particularly, a player has great interests in whether an internal win of a bonus game is determined. It has been known such gaming machine in which if the internal win of the bonus game is determined, it is performed to light a lamp (so called, WIN lamp) installed in the gaming machine and to generate as well a sound through a speaker, thereby informing of the meaning (See Japanese Patent Unexamined Publication No. 2002-17952).

### SUMMARY OF THE INVENTION

However, in the gaming machine disclosed in that document, since information is indicated by simply outputting light or sound, which may seem for a player to be easily understood at first sight, there may be caused a problem of losing the player's interest in a game because if information is so easily understood, the player is stripped of taking enjoyment in expecting on whether a desired internal win has been determined.

Accordingly, the invention has been made to solve the above-mentioned problems occurring in the prior art. An object of the invention is to provide a gaming machine capable of arousing the player's interest in a game while the player expects on whether a desired internal win has been determined.

In order to achieve the above object, according to a first aspect of the invention, there is provided a gaming machine comprising: a plurality of reels, each of which having a plurality of symbols arranged on a periphery thereof; a symbol display unit for displaying part of the symbols among those arranged on the periphery of the respective reels; a start operation detection unit for detecting a start operation; a random number sampling unit for sampling a random number based on the detection of the start operation by the start operation detecting unit; an internal lottery table memory for storing an internal lottery table defining the range of the random number determining an internal win; an internal win determining unit for determining an internal win on the basis of the random number sampled by the random number sampling unit and the internal lottery table stored in the internal lottery table memory; a reel rotation unit for rotating the respective reels if the start operation is detected by the start operation detection unit; a stop operation detection unit for detecting a stop operation according to a type of the reels; a reel stop unit for stopping rotation of a corresponding reel when the stop operation is detected by the stop operation detection unit; a symbol combination determination unit for determining a combination of the symbols displayed by the symbol display unit if rotation of the reels stops; a re-gaming unit for performing a replay if the symbol combination determination unit determines that the combination of the symbols according to the replay has been displayed; an advantageous mode operation unit for performing an operation of a game mode advantageous to a player if the symbol combination determination unit determines that a combination of the symbols according to the operation of the advantageous game mode has been displayed; a carryover unit, if the internal win determination unit determines a specified internal win according to the operation of the advantageous game mode, for carrying over the specified internal win; and a priority ranking table memory for storing a priority ranking table defining a priority rank according to the internal win, wherein if the specified internal win is determined based on a predetermined internal lottery table, the internal win determination unit determines an internal win based on a specified internal lottery table having larger range of the random number determining the internal win of the replay than that of the predetermined internal lottery table, wherein the priority ranking table is defined such that the internal win of the replay has higher priority than that of the specified internal win, and wherein if the stop operation is detected by the stop operation detection unit, the reel stop unit stops rotation of a corresponding reel, based on the internal win determined by the internal win determination unit, the specified internal win carried over by the carryover unit, and the priority ranking table.

According to the first aspect of the present invention, if a specified internal win is determined based on a predetermined internal lottery table, it is determined an internal win based on a specified internal lottery table having larger range of the random number determining the internal win of the replay than that of the predetermined internal lottery table. That is, if the specified internal win is determined, a chance for the internal win of the replay is more increased than the case where the specified internal win is not determined. Accordingly, it is done to allow a player to observe the frequency of the internal win of the replay to be displayed, thereby rending the player expecting on whether the specified internal win has been determined. In addition, it is possible to raise the player's expectation for having determined the specified internal win as the frequency of the symbol combination according to the replay to be displayed increases.

Furthermore, when the reel stops rotating, the internal win of the replay has higher priority than the specified internal win. Accordingly, when the specified internal win is carried over and the internal win of the replay is determined, the combination of the symbols according to the replay is displayed with priority. That is, since the combination of the symbols according to the operation of the advantageous game mode is hardly displayed, it is possible to increase a period until the operation of the advantageous game mode is performed after the determination of the specified internal win as well as to increase the frequency of displaying the combination of the symbols according to the replay within that period. Accordingly, it is possible to maintain the player's expectation by providing the player many chances to expect on whether the specified internal win has been determined.

Meanwhile, the replay means a game mode that when the predetermined number of gaming mediums is detected by an insertion operation detection unit for detecting the insertion operation for inserting a gaming medium, and the detection of the start operation is performed, the gaming medium according to the number used in the present unit game is automatically inserted at the next unit game (i.e., without detection of the insertion operation by the insertion operation detection unit). That is, upon the replay, it is possible for a player to play the next unit game without consuming the game medium. Accordingly, if a chance for the internal win of the replay is increased, a chance to play the next unit game without consuming the game medium is also increased.

According to a second aspect of the present invention, there is provided a gaming machine comprising: a plurality of reels, each of which having a plurality of symbols arranged on a periphery thereof; a symbol display unit for displaying part of the symbols among those arranged on the periphery of the respective reels; a start operation detection unit for detecting a start operation; a random number sampling unit for sampling a random number based on the detection of the start operation by the start operation detecting unit; an internal lottery table memory for storing an internal lottery table defining the range of the random number determining an internal win; an internal win determining unit for determining an internal win on the basis of the random number sampled by the random number sampling unit and the internal lottery table stored in the internal lottery table memory; a reel rotation unit for rotating the respective reels if the start operation is detected by the start operation detection unit; a stop operation detection unit for detecting a stop operation according to a type of the reels; a reel stop unit for stopping rotation of a corresponding reel when the stop operation is detected by the stop operation detection unit; a symbol combination determination unit for determining a combination of the symbols displayed by the symbol display unit if rotation of the reels stops; a re-gaming unit for performing a replay if the symbol combination determination unit determines that the combination of the symbols according to the replay has been displayed; an advantageous mode operation unit for performing an operation of a game mode advantageous to a player if the symbol combination determination unit determines that a combination of the symbols according to the operation of the advantageous game mode has been displayed; a carryover unit, if the internal win determination unit determines a specified internal win according to the operation of the advantageous game mode, for carrying over the specified internal win; and a priority ranking table memory for storing a priority ranking table defining a priority rank according to the internal win, wherein the internal lottery table memory stores a predetermined internal lottery table defining the range of the random number determining the specified internal win together with the internal win of the replay, wherein if the specified internal win is carried over by the carryover unit, the internal win determination unit determines an internal win based on a specified internal lottery table having larger range of the random number determining the internal win of the replay than that of the predetermined internal lottery table, wherein the priority ranking table is defined such that the internal win of the replay has higher priority than that of the specified internal win, and wherein if the stop operation is detected by the stop operation detection unit, the reel stop unit stops rotation of a corresponding reel, based on the internal win determined by the internal win determination unit, the specified internal win carried over by the carryover unit, and the priority ranking table.

According to the second aspect of the present invention, if a specified internal win is carried over, it is determined an internal win based on a specified internal lottery table having larger range of the random number determining the internal win of the replay than that of a predetermined internal lottery table. That is, if the specified internal win is carried over, a chance for the internal win of the replay is more increased than the case where the specified internal win is not carried over. Accordingly, it is done to allow a player to observe the frequency of the internal win of the replay to be displayed, thereby rending the player expecting on whether the specified internal win has been carried over. In addition, it is possible to raise the player's expectation for having carried over the specified internal win as the frequency of the symbol combination according to the replay to be displayed increases.

Furthermore, since when the reel stops rotating, the internal win of the replay has higher priority than the specified internal win, the combination of the symbols according to the replay is displayed with priority, relative to the combination of the symbols according to the operation of the advantageous game mode.

Here, on the predetermined internal lottery table, the range of the random number determining the specified internal win together with the internal win of the replay is defined. That is, if the sampled random number is included in a corresponding random number range, the specified internal win and the internal win of the replay are determined together. Accordingly, since the display of the combination of the symbols according to the operation of the advantageous game mode is avoided at a unit game in which the specified internal win is determined, it is possible to prevent for the player from being stripped of a chance to expect on whether the specified internal win has been determined.

Further, when the specified internal win is carried over and the internal win of the replay also is determined, since the combination of the symbols according to the operation of the advantageous game mode is hardly displayed, it is possible to increase a period until the operation of the advantageous game mode is performed after the determination of the specified internal win as well as to increase the frequency of displaying the combination of the symbols according to the replay within the period. Accordingly, since the combination of the symbols according to the operation of the advantageous game mode is hardly displayed from a unit game in which the specified internal win is determined, it is possible to maintain the player's expectation by providing the player many chances to expect on whether the specified internal win has been determined.

### BRIEF DESCRIPTION OF THE DRAWINGS

Other and further objects, features and advantages of the invention will appear more fully from the following description taken in connection with the accompanying drawings, in which:

FIG. 1 is a perspective view showing a gaming machine according to an embodiment of the invention;

FIG. 2 is a view showing an example of symbols arranged on reels provided to a gaming machine;

FIG. 3 is a block diagram of an electric circuit of a gaming machine;

FIG. 4 is a view showing a symbol arrangement table of a gaming machine;

FIG. 5 is a view showing a determination table for an internal lottery table of a gaming machine;

FIGS. 6 to 9 are views showing examples of an internal lottery table of a gaming machine;

FIG. 10 is a view showing a determination table for an internal win of a gaming machine;

FIG. 11 shows a reel stop initialization table of a gaming machine;

FIGS. 12A and 12B are views showing a priority ranking table of a gaming machine;

FIG. 13 shows a symbol combination table of a gaming machine;

FIG. 14 shows a table under bonus operation of a gaming machine;

FIG. 15 is a view showing a storing area of an internal win, provided to a RAM of a main control circuit of a gaming machine;

FIG. 16 is a view showing a storing area of a carryover win, provided to a RAM of a main control circuit;

FIG. 17 is a view showing a symbol storing area provided to a RAM of a main control circuit;

FIG. 18 is a flow chart showing a RESET intervention process carried out by a main control circuit;

FIG. 19 is flow chart showing a bonus operation supervisory process provided to a RAM of a main control circuit;

FIG. 20 is a medal insertion-start checking process by a main control circuit;

FIG. 21 is a flow chart showing an internal lottery process by a main control circuit;

FIG. 22 is a flow chart showing a reel stop initialization process by a main control circuit;

FIG. 23 is a flow chart showing a reel stop control process by a main control circuit;

FIG. 24 is a flow chart showing a display win retrieval process by a main control circuit;

FIG. 25 is a flow chart showing a bonus operation checking process by a main control circuit;

FIG. 26 is a flow chart showing a bonus end checking process by a main control circuit;

FIG. 27 is a flow chart showing an intervention process having a period of 1.1173 msec by a main control circuit;

FIG. 28 is a flow chart showing a RESET intervention process by a sub control circuit of a gaming machine;

FIG. 29 is a flow chart showing a command receiving process by a sub control circuit; and

FIG. 30 is a flow chart showing a start command response process by a sub control circuit.

### DESCRIPTION OF THE PREFERRED EMBODIMENTS

Hereinafter, it will be described a preferred embodiment of the present invention with reference to the drawings.

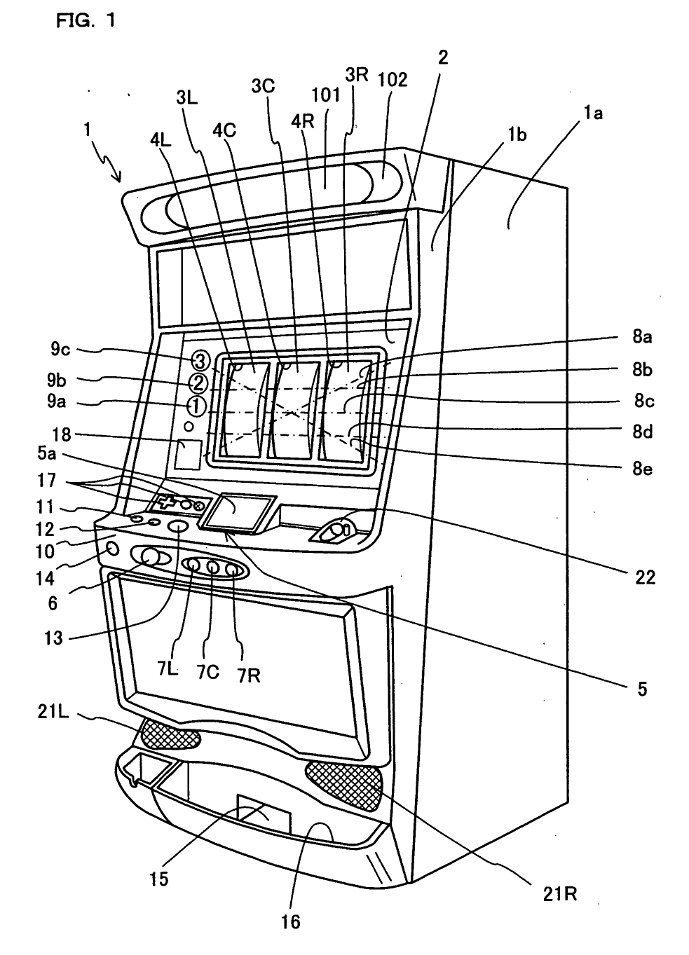

First, a gaming machine 1 according to an embodiment of the invention is schematically described with reference to FIG. 1.

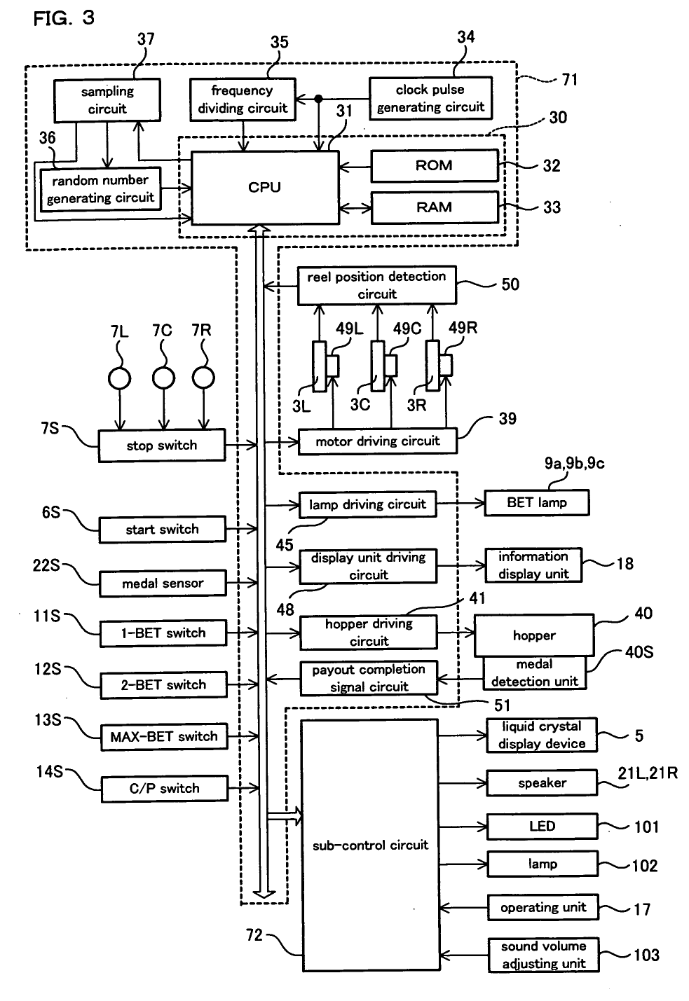

The gaming machine 1 has a cabinet 1a receiving reels 3L, 3C, 3R, a main control circuit 71 (see FIG. 3) and the like which will be described later, and a front door 1b which is mounted to be opened and closed with regard to the cabinet 1a.

The three reels 3L, 3C, and 3R are horizontally mounted in a row in the cabinet 1a. Symbols are continuously arranged in a rotation direction of the reel on a periphery of each of the reels 3L, 3C, and 3R. Each of the reels 3L, 3C, and 3R is controlled to rotate at a constant speed (for example, 80 revolutions/minute) by the main control circuit 71 which will be described later. The symbols arranged on the peripheries of the reels 3L, 3C, and 3R are varied as the reels are rotated.

A panel display unit 2 having an approximately horizontal surface is provided to the front door 1b, and three display windows 4L, 4C, 4R having a rectangular shape are mounted to a center of the panel display unit 2, as symbol display areas. Each of the display windows 4L, 4C, 4R is mounted to be located in front of the corresponding reels 3L, 3C, 3R, so that it is possible to observe the rotation and stopping of the reels 3L, 3C, 3R through the display windows 4L, 4C, 4R. One symbol is displayed in each of the upper, central and lower areas of the respective display windows 4L, 4C, 4R, so that three symbols of the symbols arranged on the corresponding reels are displayed in the respective display windows 4L, 4C, 4R.

Five lines are formed in the display windows 4L, 4C, 4R, which connect predetermined areas of the upper, central and lower areas of the respective display windows 4L, 4C, 4R. In particular, the lines include a top line 8b, a center line 8c, a bottom line 8d, a cross-up line 8a and a cross-down line 8e.

The center line 8c is a line connecting the central areas of the respective display windows 4L, 4C, 4R each other. The top line 8b is a line connecting the upper areas of the respective display windows 4L, 4C, 4R each other. The bottom line 8d is a line connecting the lower areas of the respective display windows 4L, 4C, 4R each other. The cross-up line 8a is a line connecting the lower area of the left display windows 4L, the central area of the center display window 4C and the upper area of the right display window 4R each other. The cross-down line 8e is a line connecting the upper area of the left display windows 4L, the central area of the center display window 4C and the lower area of the right display window 4R each other. Meanwhile, the center line 8c is one predetermined line of lines. The top line 8b, the bottom line 8d, the cross-up line 8a, and the cross-down line 8e are an example of different lines from the predetermined line.

A medal insertion slot 22 for inserting a medal into the gaming machine 1 is provided to a right side of a liquid crystal display device 5. When the medal is inserted through the medal insertion slot 22, the center line 8camong the five lines is activated (a line which is activated is generally referred to as an “active line”). When the three medals are continuously inserted from the medal insertion slot 22, they are deposited (i.e., credited) in the gaming machine 1. In the mean time, the gaming machine 1 uses a medal as a game medium. However, the game medium used in the gaming machine 1 is not limited to the medal, and a coin, a gaming ball, a token, a card storing information about an amount of the medals, and the like may be applied.

A 1-BET button 11, a 2-BET button 12 and a MAX-BET button 13 for determining the number of medals inserted for a unit game (e.g., for one game performed after the reels are started to rotate until the rotation of reels is stopped and thus a win or lose is determined) from the credited medals are mounted to a left side of the liquid crystal display device 5. When the 1-BET button 11 is pushed, one piece is inserted from the medals credited, when the 2-BET button 12 is pushed, two pieces are inserted, and when the MAX-BET button 13 is pushed, three pieces are inserted.

To the left side of the display windows 4L, 4C, 4R are mounted a 1-BET lamp 9a, a 2-BET lamp 9b and a MAX-BET lamp 9c. The 1-BET lamp 9a, 2-BET lamp 9b and MAX-BET lamp 9c are turned on in correspondence with the number of medals inserted in the unit game (hereinafter, referred to as “insertion number”). When the insertion number is one, two and three pieces, the 1-BET lamp 9a, the 2-BET lamp 9b and the MAX-BET lamp 9c are turned on, respectively.

An information display unit 18 is mounted below the BET lamps 9a, 9b, 9c. The information display unit 18 consists of 7 segment LEDs and displays the number of medals deposited (so-called “credited”) in the gaming machine 1, the number of medals to be paid out to a player (hereinafter, referred to as “payout number”) and the like.

A base portion 10 having a horizontal surface is provided below the display windows 4L, 4C, 4R, and the liquid crystal display device 5 is provided between the base portion 10 and the display windows 4L, 4C, 4R. The information about the game, etc. is displayed on a display screen 5a of the liquid crystal display device 5.

An operating unit 17 is mounted above the BET buttons 11, 12, 13, which consists of a cross key, a selection button and a determination button. Based on a manipulation of the operating unit 17 by the player, the information about the game such as game history is displayed on display screen 5a of the liquid crystal display device 5.

A C/P button 14 for switching credits (Credit) or payouts (Pay) of medals is mounted to a frontal left side of the base portion 10. When the payout is carried out, the medals as the payout number are paid out from a frontal lower medal payout slot 15 and stacked on a medal tray 16. When the credit is carried out, the medals as the payout number are credited. Herein, the payout and credit of the medal may be simply referred to as “payout”.

To a right side of the C/P button 14 is mounted a start lever 6 for rotating the reels 3L, 3C, 3R and starting the variation of the symbols displayed in the display windows 4L, 4C, 4R.

Stop buttons 7L, 7C, 7R which are mounted to correspond to the reels 3L, 3C, 3R and stop the rotation of the reels 3L, 3C, 3R are mounted below the liquid crystal display device 5, in the frontal center of the base portion 10.

Hereinafter, a stop operation which is first of all carried out when all the reels 3L, 3C, 3R are rotated (i.e., a player's push operation for the stop buttons 7L, 7C, 7R) will be referred to as “first stop operation”, a stop operation which is carried out following the first stop operation when the two reels are rotated will be referred to as “second stop operation”, and a stop operation which is carried out following the second stop operation when the remaining one reel is rotated will be referred to as “third stop operation”.

A LED 101 and a lamp 102 are mounted at the upper part of the front door 1b. The LED 101 and the lamp 102 emit lights with a radiation pattern corresponding to game situations, and perform an effect relating to a game.

Speakers 21L, 21R are mounted at upper left and right sides of the medal tray 16. Sound such as effect sound or sing corresponding to the game situations is outputted from the speakers 21L, 21R to perform the effect relating to a game.

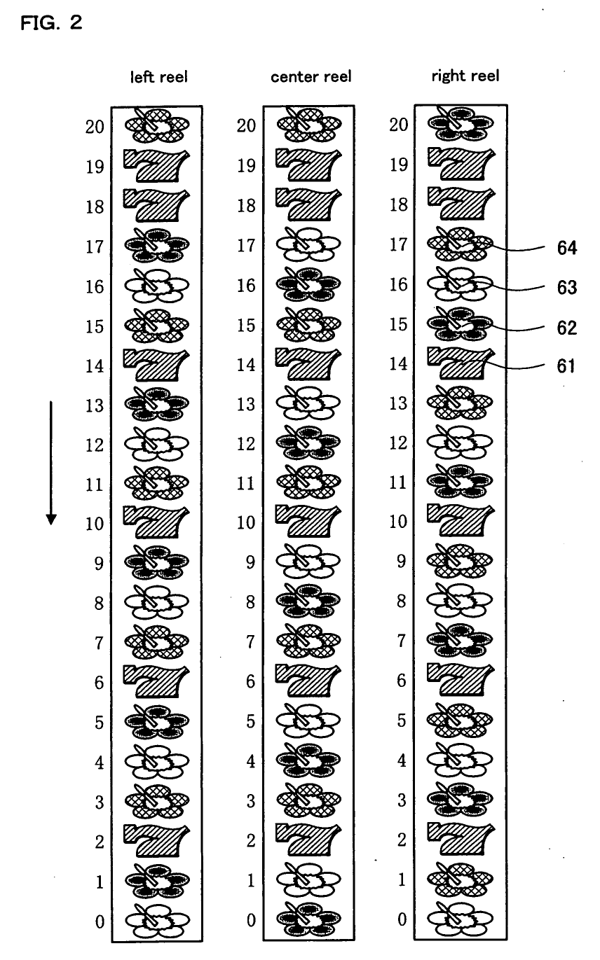

In the followings, it is described symbols arranged on the reels 3L, 3C, 3R, with reference to FIG. 2. 371 The types of 21 symbols are arranged on the respective reels 3L, 3C, 3R. Specifically, 21 areas are provided on the periphery of each of the reels 3L, 3C, 3R, each of which being allotted with a one symbol. Each symbol of 7 (symbol 61), red flower (symbol 62), yellow flower (symbol 63), and blue flower (symbol 64) is arranged on each of the corresponding areas. Each of the reels 3L, 3C, 3R is rotated in an arrow direction of FIG. 2.

In the followings, it is described a circuit structure of the gaming machine 1 having a main control circuit 71, a sub-control circuit 72 and a peripheral device such as actuator electrically connected to the main control circuit 71 or a sub-control circuit 72, with reference to FIG. 3.

The main control circuit 71 has a micro computer 30 arranged on a circuit board as a main constituting element and is further provided with a circuit for sampling random numbers. The micro computer 30 includes a CPU 31 and a ROM 32 and a RAM 33 which are memory units.

To the CPU 31 is connected a clock pulse generating circuit 34, a frequency dividing circuit 35, a random number generating circuit 36 and a sampling circuit 37. The clock pulse generating circuit 34 and the frequency dividing circuit 35 generate a reference clock pulse. Based on the generated reference clock pulse, an intervention process which will be described later is carried out. The random number generating circuit 36 generates a random number within a predetermined range (for example, 0 to 65535). The sampling circuit 37 extracts one random number from the random numbers generated by the random number generating circuit 36. By using the sampled random number, an internal lottery process and the like are carried out, which will be described later, and predetermined information such as later-described winning number is determined.

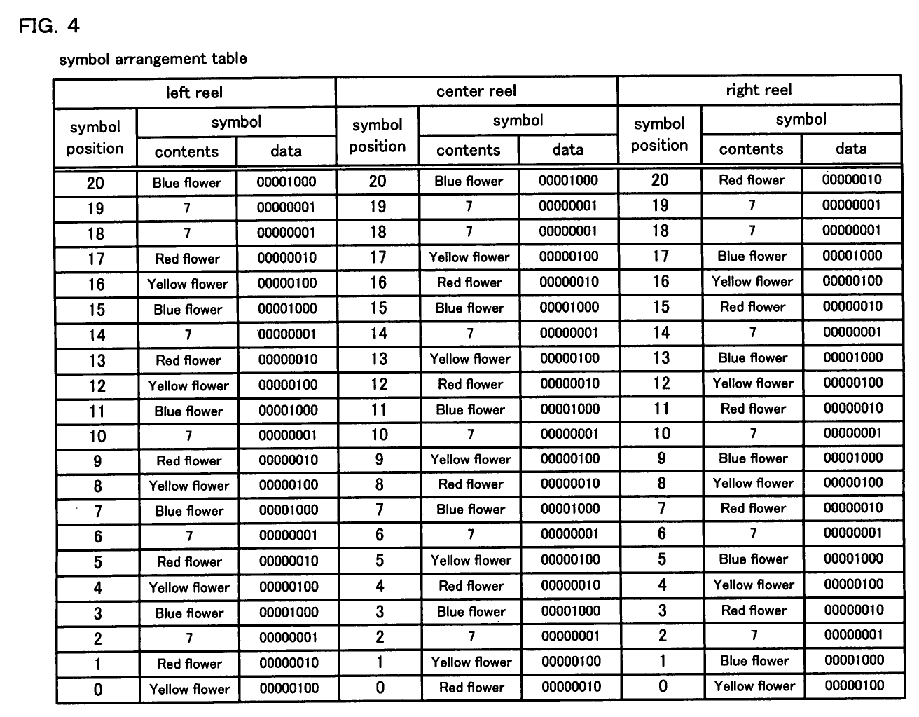

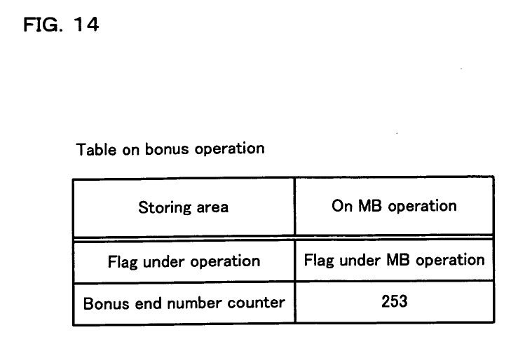

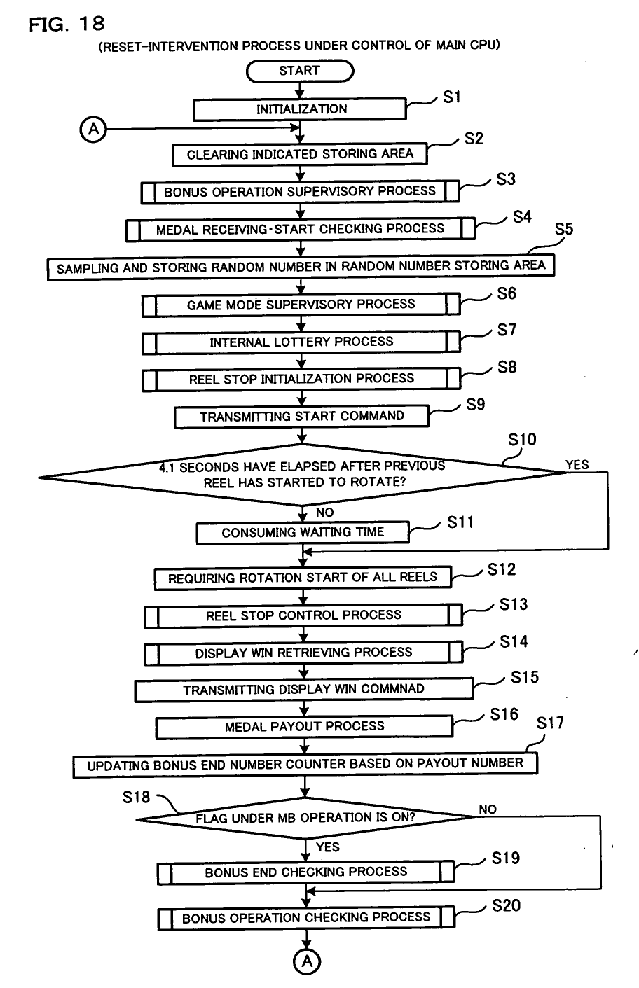

The ROM 32 of the micro computer 30 memorizes programs relating to processes of the CPU 31 (See FIGS. 18 to 27 described later), various tables such as an internal lottery table and others (See FIGS. 4 to 14 described later), and various control commands for transmitting data to the sub-control circuit 72.

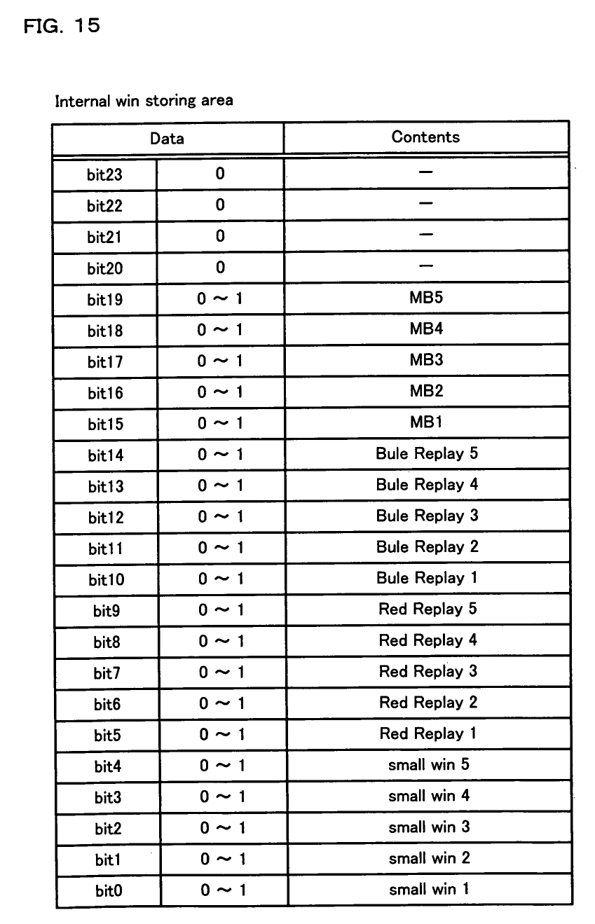

Various data obtained from the processes of the CPU 31 is memorized in the RAM 33. For example, an area (see FIGS. 15 to 17) for storing an internal win, which will be described later, is provided therein. These data are transmitted to the sub-control circuit 72 by the commands.

In the circuit shown in FIG. 3, main actuators controlled by a control signal from the micro computer 30 include the BET lamps 9a, 9b, 9c, the information display unit 18, a hopper 40, stepping motors 49L, 49C, 49R and the like.

To an output unit of the micro computer 30 are connected each of circuits for receiving the control signals outputted from the CPU 31 to control the operations of the respective actuators. The circuits include a motor driving circuit 39, a lamp driving circuit 45, a display unit driving circuit 48 and a hopper driving circuit 41.

The lamp driving circuit 45 controls the driving of the BET lamps 9a, 9b, 9c. Thereby, the BET lamps 9a, 9b, 9c are turned on or off.

The display unit driving circuit 48 controls the driving of the information display unit 18. Thereby, various kind of information such as a credit number is displayed on the information display unit 18.

The hopper driving circuit 41 controls the driving of the hopper 40. Thereby, the medals received in the hopper 40 are paid out.

The motor driving circuit 39 outputs the pulse coming from the main control circuit 71 to the stepping motors 49L, 49C, 49R and controls the driving of the stepping motors 49L, 49C, 49R. Thereby, the reels 3L, 3C, 3R are rotated and stopped.

In this embodiment, it is counted the number of pulses outputted to the stepping motors 49L, 49C, 49R from after a reel index indicating one revolution of the reel is detected by a reel position detection circuit 50, so that a rotation angel of the reel is detected on the basis of the detected position of the reel index. The pulse is outputted 16 times to the stepping motors 49L, 49C, 49R, so that the reel is rotated by one symbol arranged on the periphery of the reel.

Specifically, the number of pulses outputted to the stepping motors 49L, 49C, 49R is counted by an impulse counter of the RAM 33, and a symbol counter of the RAM 33 is added by one whenever 16 times of pulse outputs are counted by the impulse counter. A value of the symbol counter is cleared whenever the reel index is detected.

Each of the symbols arranged on the periphery of the reel is defined with symbol positions “0” to “20” for discriminating each of the symbols in regular order from the rotation direction of the reel. The reel index is detected by a reel position detection circuit 50 so that the symbol corresponding to the symbol position “0” is located on the center line 8c (more specifically, on the center part of the longitudinal direction of the respective display windows 4L, 4C, 4R). The center line 8c is an example of a position.

In other words, when the value of the symbol counter becomes “0” by the detection of the reel index, the symbol corresponding to the symbol position “0” is located on the center line 8c, so that the symbol counter and the symbol position correspond to each other. Accordingly, by referring to the symbol counter, it is possible to specify the symbol located on the center line 8c.

In the mean time, in the present embodiment, while a symbol on the center line is specified by the symbol counter, the position where the symbol is specified by the symbol counter can be freely changed. For example, the reel index may be detected such that the symbol in its position of “0” is located on the top line 8b or bottom line 8d. In this case, the symbol located on the bottom line 8d (or the top line 8b) is specified by the symbol counter.

To an input unit of the micro computer 30 are connected switches and the like which output predetermined signals performing the controls of the actuators. Specifically, a start switch 6S, a stop switch 7S, a 1-BET switch 118S a 2-BET switch 12S, a MAX-BET switch 13S, a C/P switch 14S, a medal sensor 22S, the reel position detection circuit 50 and a payout completion signal circuit 51 are connected.

The start switch 6S detects the start operation of the player for the start lever 6 and outputs a detected signal to the micro computer 30.

The stop switch 7S detects the stop operation of the player for the respective stop buttons 7L, 7C, 7R and outputs a detected signal to the micro computer 30.

The 1-BET switch 11S, the 2-BET switch 12S and the MAX-BET switch 13S detect the insertion operations of the player for the 1-BET button 11, the 2-BET button 12 and the MAX-BET button 13, respectively, and output a detected signal to the micro computer 30.

The C/P switch 14S detects the switching operation of the player for the C/P button 14 and outputs a detected signal to the micro computer 30.

The medal sensor 22S detects a medal inserted into the medal insertion slot 22 by the player and outputs a detected signal to the micro computer 30

The reel position detection circuit 50 detects the reel index indicating one revolution of the reel for each of the reels 3L, 3C, 3R and outputs a detected signal to the micro computer 30.

The payout completion signal circuit 51 detects that the number of medals (i.e., the number of medals paid out from the hopper 40) reaches a designated payout number through a medal detection unit 40S and outputs a detected signal to the micro computer 30.

Next, the structure of the sub-control circuit 72 will now be described. The main control circuit 71 controls overall game such as the proceeding of game while the sub-control circuit 72 controls an effect on game with image display or out of sound and lamp and the like. The main control circuit 71 and the sub-control circuit 72 are electrically connected through a harness and the like, and the sub-control circuit 72 executes various processes, for example, determination or execution of contents of effect, based on the various commands such as a start command which will be described later outputted from the main control circuit 71.

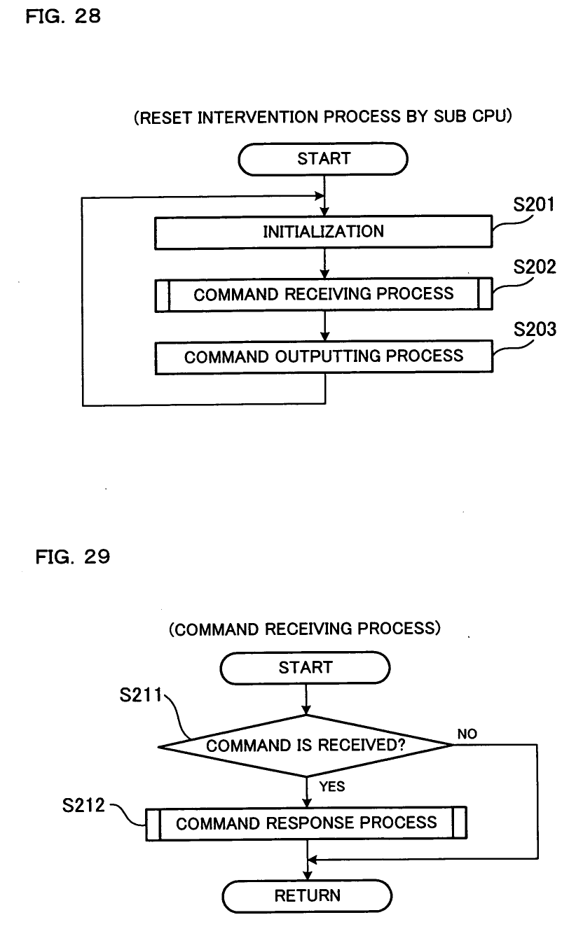

As is not shown in the drawings, the sub-control circuit 72 includes a sub-CPU, a serial port, a sub-ROM, a sub-RAM, a random number generating circuit and the like. The sub-CPU performs various processes such as the determination and the output of effect data such as image information, lighting pattern information, and sound information according to a control program (for example, see FIGS. 28 to 30 which will be described later) stored in the sub-ROM, based on the transmitted commands from the main control circuit 71 via the serial port. The sub RAM functions as a temporal memory for operation when the sub-CPU executes the control program, and stores therein information obtained from various commands received from the main control circuit 71.

The main actuators controlled by the sub-control circuit 72 include the liquid crystal display device 5, the speakers 21L, 21R, the LED 101 and the lamp 102. The sub-control circuit 72 determines and displays an image to be displayed on the liquid crystal display device 5, determines and outputs a lighting-up pattern of the LED 101 or lamp 102, and determines and outputs effect sound, based on the contents of effect determined.

The sub-control circuit 72 is connected with the operating unit 17 and a sound volume adjusting unit 103 and outputs an image or sound, based on the signal outputted from them.

In the followings, a symbol arrangement table is described with reference to FIG. 4.

The symbol arrangement table shows the symbols arranged on the peripheries of the reels 3L, 3C, 3R, as data. In other words, the symbol arrangement table defines 7, red flower, yellow flower, and blue flower in an arrangement as shown in FIG. 2. The type of each symbol is displayed in data of 1 byte. For example, data indicative of 7 is “00000001”, and data indicative of the blue flower is “00001000”.

With the symbol located on the center line 8c being defined as the symbol position “0” when the reel index is detected, the symbol arrangement table defines the symbol positions “0” to “20” corresponding to the symbol counter and types of symbols corresponding to the respective symbol positions. Accordingly, based on the symbol arrangement table and the symbol counter, symbols of the respective reels 3L, 3C, 3R on the center line 8c and types thereof can be specified. For example, when the symbol counter of the right reel 3R is “14”, it is specified that 7 (symbol 61) of the symbol position “14” of the right reel 3R is located on the center line 8c. By referring to the symbol counter and the symbol arrangement table, besides the symbol located on the center line 8c, it is possible to specify symbols adjacent to the corresponding symbol and types thereof. In the mean time, the symbol arrangement table constitutes a part of a symbol specifying unit.

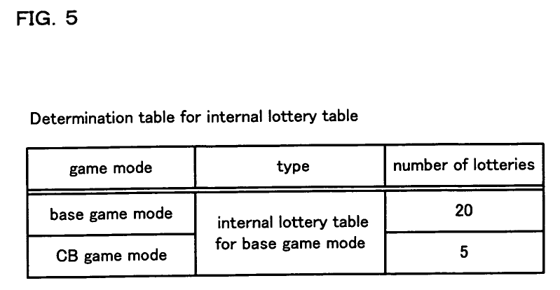

In the followings, a determination table for internal lottery table is described with reference to FIG. 5.

The determination table for internal lottery table defines a type of an internal lottery table and the number of lotteries, which are determined in accordance with the game modes. In a base game mode and a challenge bonus (hereinafter referred to as “CB”), it is determined an internal lottery table for the base game mode, and the number of lotteries is basically determined to be 20. In the CB game mode, the number of lotteries is determined to be 5. Meanwhile, as described later, the transfer from the base game mode to the CB game mode is carried out while on operation of middle bonus (hereinafter referred to as “MB”).

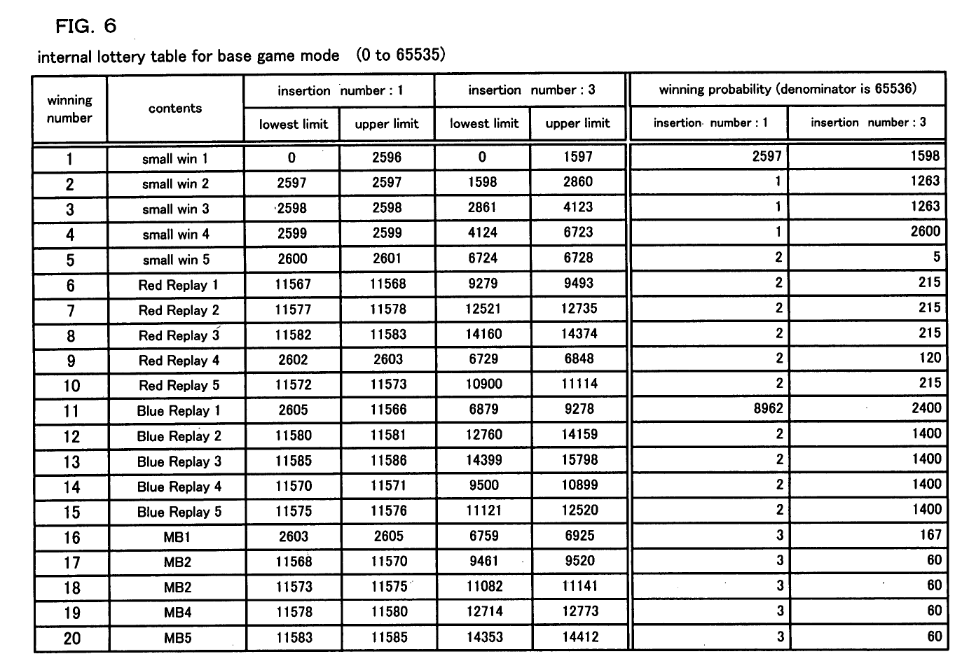

In the followings, an internal lottery table is described with reference to FIGS. 6 to 9.

The internal lottery table defines a range of random numbers, i.e., the lower and upper limits of random numbers allotted in accordance with each of winning numbers. The winning number is data used to determine an internal win on the basis of a determination table for internal win which will be described later.

In the internal lottery table, it is retrieved whether the random number sampled from a range of “0 to 65535” is included between the lower limit and the upper limit of the random numbers allotted to the respective winning numbers, in descending order of the winning numbers. When the sampled random number is included between the lowest limit and the upper limit, a corresponding winning number is determined. The number of lotteries indicates the number of the above retrievals. As a result of performing the retrieval as the number of lotteries, when any winning number is not matched, the winning number 0 (i.e., Losing) is determined.

Herein, the magnitude of the random number determining the winning number is obtained by adding 1 to the difference between the upper limit and lower limit defined in each winning number. The probability of determining the corresponding winning number is positively proportional to the number. That is, a winning probability of each winning number can be calculated by “(1+difference between the lower and upper limits defined for each winning number)/the number of all random numbers occurring in the table, i.e., 65536”. In the internal lottery table for the base game mode, the greater the insertion number, the higher the winning probability by stages. Meanwhile, in the present embodiment, while the random number is not defined for the insertion number 2, it may also be defined for that insertion number 2. In the respective internal lottery tables shown in FIGS. 6 to 9, although “content” and “winning probability” corresponding to the winning number are included for convenience of description, in fact, these items are not defined as data in an internal lottery table.

FIG. 6 shows an internal lottery table for the base game mode. In the internal lottery table for the base game mode, the lower and upper limits of the random number allotted to each of the winning numbers 1 to 20 are defined.

In the internal lottery table for the base game mode, there is defined a random number overlapped for the winning numbers. When the overlapped random number is sampled, the winning numbers are together determined.

In particular, when the insertion number is 3, the range of the random number defined by the winning number 16 (MBI) is “6759 to 6925”, the range of the random number defined by the winning number 9 (red Replay 4) is “6729 to 6848”, and the range of the random number defined by the winning number 11 (blue Replay 1) is “6879 to 9278”. Accordingly, in the winning numbers 16 and 9, the range of “6759 to 6848” is overlapped with each other, and when the sampled random number is within the corresponding range, the winning numbers 16 and 9 are determined together.

In the case of the insertion number of 3, when the sampled random number is within the range of “9461 to 9493”, the winning number 17 (MB2) and the winning number 6 (red Replay 1) are determined together. When the sampled random number is within the range of “9500 to 9520”, the winning number 17 and the winning number 14 (blue Replay 4) are determined together. Accordingly, when the winning number 17 is determined, any one of the winning numbers 6 and 14 has the possibility to be determined.

In the case of the insertion number of 3, when the sampled random number is within the range of “11082 to 11114”, the winning number 18 (MB3) and the winning number 10 (red Replay 5) are determined together. When the sampled random number is within the range of “11121 to 11141”, the winning number 18 and the winning number 15 (blue Replay 5) are determined together. Accordingly, when the winning number 18 is determined, any one of the winning numbers 10 and 15 has the possibility to be determined.

In the case of the insertion number of 3, when the sampled random number is within the range of “12714 to 12735”, the winning number 19 (MB4) and the winning number 7 (red Replay 2) are determined together. When the sampled random number is within the range of “12760 to 12773”, the winning number 19 and the winning number 12 (blue Replay 2) are determined together. Accordingly, when the winning number 19 is determined, any one of the winning numbers 7 and 12 has the possibility to be determined.

In the case of the insertion number of 3, when the sampled random number is within the range of “14353 to 14374”, the winning number 20 (MB5) and the winning number 8 (red Replay 3) are determined together. When the sampled random number is within the range of “14399 to 14412”, the winning number 20 and the winning number 13 (blue Replay 3) are determined together. Accordingly, when the winning number 20 is determined, any one of the winning numbers 8 and 13 has the possibility to be determined.

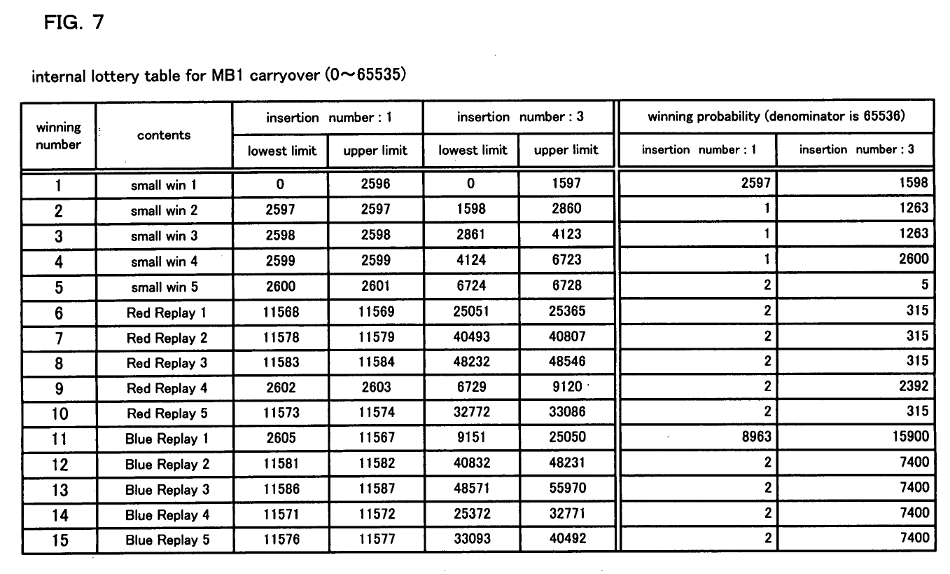

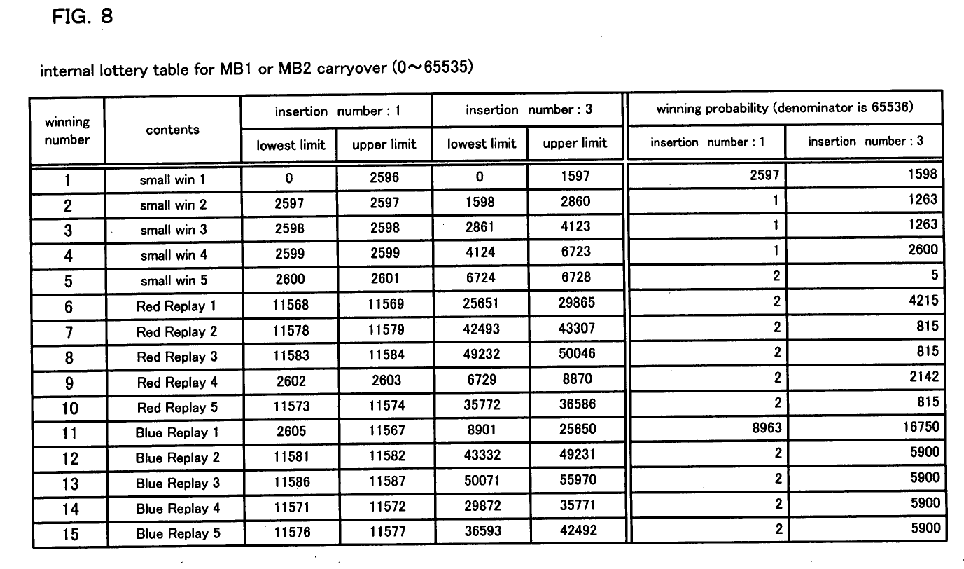

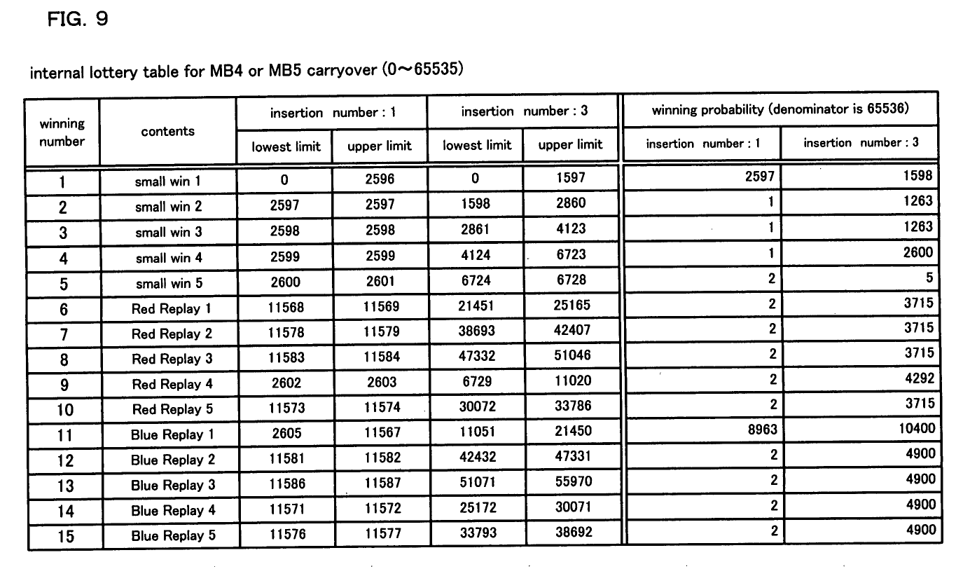

Each of FIGS. 7 to 9 shows an internal lottery table for carryover. The internal lottery table for carryover win includes an internal lottery table for MB1 carryover as shown in FIG. 7, an internal lottery table for MB2 or MB3 carryover as shown in FIG. 8, and an internal lottery table for MB4 or MB5 carryover as shown in FIG. 9, according to the types of MB determined based on an internal lottery table for the base game mode (and on a determination table for internal win which will be described later).

In the internal lottery table for carryover, it is defined the lower and upper limits of the random numbers allocated to the respective winning numbers 1 to 15. That is, in the internal lottery table for carryover, the winning numbers 16 to 20 (MB1 to MB5 which will be described later) are not defined and these are not determined.

Although the winning probability of the respective winning numbers in the internal lottery table for carryover is basically identical to those of the internal lottery table for the base game mode, when the insertion number is 3 in the internal lottery table for carryover, the respective winning probabilities of the winning numbers 6 to 15 (red Replay 1 to blue Replay 5) is set to be higher than those of the internal lottery table for the base game mode. Detailed construction thereof will now be described.

In the internal lottery table for the base game mode, the overall winning probability (i.e., the sum of the respective winning probabilities) of the winning numbers 6 to 15 (red Replay 1 to blue Replay 5) is “8980” (a denominator thereof is omitted as in the following cases) which can be obtained by adding each winning probability from “215” of the winning number 6 to “1400” of the winning number 15. The overall winning probability of the winning numbers 6 to 10 (red Replay 1 to red Replay 5) is “980”. In the winning numbers 6 to 10, the winning probability of the winning number 9 is the lowest (i.e., 120), and those of the other winning numbers are the same (i.e., 215). The overall winning probability of the winning numbers 11 to 15 (blue Replay 1 to blue Replay 5) is “8000”. In the winning numbers 11 to 15, the winning probability of the winning number 11 (blue Replay 1) is the highest (i.e., 2400), and those of the other winning numbers are the same (i.e., 1400). The overall winning probability of the winning numbers 11 to 15 is higher than that of the winning numbers 6 to 10.

In the internal lottery table for MB1 carryover, the overall winning probability of the winning numbers 6 to 15 is “49152”. The overall winning probability of the winning numbers 6 to 10 is “3652”. In the winning numbers 6 to 10, the winning probability of the winning number 9 is the highest (i.e., 2392), and those of the other winning numbers are the same (i.e., 315). The overall winning probability of the winning numbers 11 to 15 is “45500”. In the winning numbers 11 to 15, the winning probability of the winning number 11 is the highest (i.e., 15900), and those of the other winning numbers are the same (i.e., 7400).

In the internal lottery table for MB2 or MB3 carryover, the overall winning probability of the winning numbers 6 to 15 is “49152”. The overall winning probability of the winning numbers 6 to 10 is “8802”. In the winning numbers 6 to 10, the winning probability of the winning number 6 (red Replay 1) is the highest (i.e., 4219), that of the winning number 9 is the next highest (i.e., 2142), and those of the other winning numbers are the same (i.e., 815). The overall winning probability of the winning numbers 11 to 15 is “40350”. In the winning numbers 11 to 15, the winning probability of the winning number 11 is the highest (i.e., 16750), and those of the other winning numbers are the same (i.e., 5900).

In the internal lottery table for MB4 or MB5 carryover, the overall winning probability of the winning numbers 6 to 15 is “49152”. The overall winning probability of the winning numbers 6 to 10 is “19152”. In the winning numbers 6 to 10, the winning probability of the winning number 9 is the highest (i.e., 4292), and those of the other winning numbers are the same (i.e., 3715). The overall winning probability of the winning numbers 11 to 15 is “30000”. In the winning numbers 11 to 15, the winning probability of the winning number 11 is the highest (i.e., 10400), and those of the other winning numbers are the same (i.e., 4900).

In the above construction, considering the overall winning probability of the winning numbers 6 to 10, it can be noted that the respective internal lottery tables have the same values. Accordingly, in-between the types of the respective MBs, the increments of the winning probability from those of the internal lottery table for the base game mode are the same.

Considering the overall winning probability of the winning numbers 6 to 10, it can be noted that the internal lottery table for MB4 or MB5 carryover has the highest value, the internal lottery table for MB2 or MB3 carryover has the next highest value, and the internal lottery table for MB1 carryover has the lowest value.

Considering the overall winning probability of the winning numbers 11 to 15, it can be noted that the internal lottery table for MB1 carryover has the highest value, the internal lottery table for MB2 or MB3 carryover has the next highest value, and the internal lottery table for MB4 or MB5 carryover has the lowest value.

Considering the respective winning probabilities of the winning numbers 6 to 10, it can be noted that for the winning number 9, the internal lottery table for MB4 or MB5 carryover has the highest value, the internal lottery table for MB1 carryover has the next highest value, and the internal lottery table for MB2 or MB3 carryover has the lowest value. It can be noted that for the winning number 6, the internal lottery table for MB2 or MB3 carryover has the highest value, the internal lottery table for MB4 or MB5 carryover has the next highest value, and the internal lottery table for MB1 carryover has the lowest value. It can be noted that for the winning numbers 7, 8, and 10, the internal lottery table for MB4 or MB5 carryover has the highest value, the internal lottery table for MB2 or MB3 carryover has the next highest value, and the internal lottery table for MB1 carryover has the lowest value.

Considering the respective winning probabilities of the winning numbers 11 to 15, it can be noted that for the winning number 11, the internal lottery table for MB2 or MB3 carryover has the highest value, the internal lottery table for MB4 or MB5 carryover has the next highest value, and the internal lottery table for MB1 carryover has the lowest value. It can be noted that for the winning numbers 12 to 15, the internal lottery table for MB1 carryover has the highest value, the internal lottery table for MB2 or MB3 carryover has the next highest value, and the internal lottery table for MB4 or MB5 carryover has the lowest value.

Like this, in the internal lottery table for carryover provided according to the type of the respective MBs, the increments of the winning probability from the internal lottery table for the base game mode are different for the winning numbers 6 to 15.

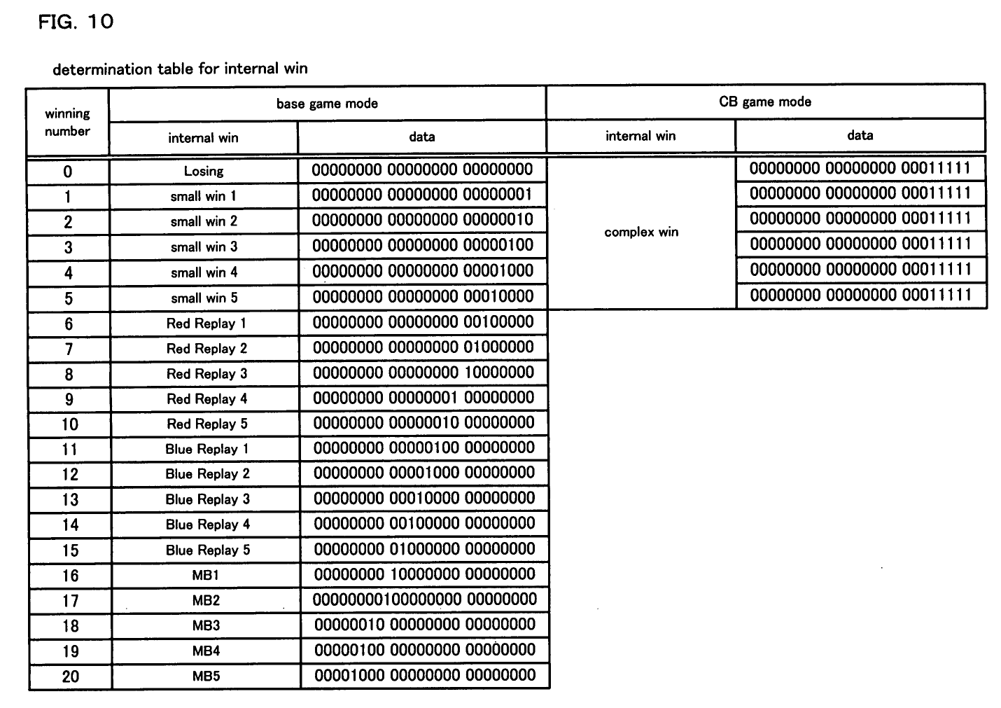

In the followings, a determination table for an internal win is described with reference to FIG. 10.

The determination table for internal win defines an internal win in relation to the winning number as described above. Specifically, in the base game mode, each of Losing, small win 1, small win 2, small win 3, small win 4, small win 5, red Replay 1, red Replay 2, red Replay 3, red Replay 4, red Replay 5, blue Replay 1, blue Replay 2, blue Replay 3, blue Replay 4, blue Replay 5, MB1, MB2, MB3, MB4, and MB5 is defined in correspondence with each of the winning numbers 0 to 20. The types of the respective internal wins are indicated in 3 byte data as shown in the drawing, and the bits according to the types of the internal wins are turned ON. For example, data indicative of MB1 is displayed by turning ON of the bit 15.

Herein, the small win1, the small win2, the small win3, the small win4, and the small win5 may be hereinafter in general referred to as “small win”. The red Replay 1, the red Replay 2, the red Replay 3, the red Replay 4, and the red Replay 5 may be in general referred to as “red Replay”. The blue Replay 1, the blue Replay 2, the blue Replay 3, the blue Replay 4, and the blue Replay 5 may be in general referred to as “blue Replay”. The red Replay and the blue Replay may be in general referred to as “Replay”. MB1, MB2, MB3, MB4, and MB5 may be in general referred to as “MB”.

In the CB game mode, a complex win is defined in common in each of the winning numbers 0 to 5. That is, in the CB game mode, the complex win should be determined as an internal win, irrespective of a type of the winning number determined (i.e., irrespective of a result of the lottery by the internal lottery table). Data indicative of the complex win are indicated as turning ON of all bits 0 to 4. That is, if the complex win is determined, it is considered as if the small win 1, the small win 2, the small win 3, the small win 4, and the small win 5 have been determined together, so that it is possible to display on an active line a combination of the symbols according to any one of the small win 1, the small win 2, the small win 3, the small win 4, and the small win 5.

Meanwhile, since if a winning number is determined by the internal lottery table described above, an internal win according to the corresponding winning number is determined, it can be said that the determination of the winning number is equivalent to that of the internal win.

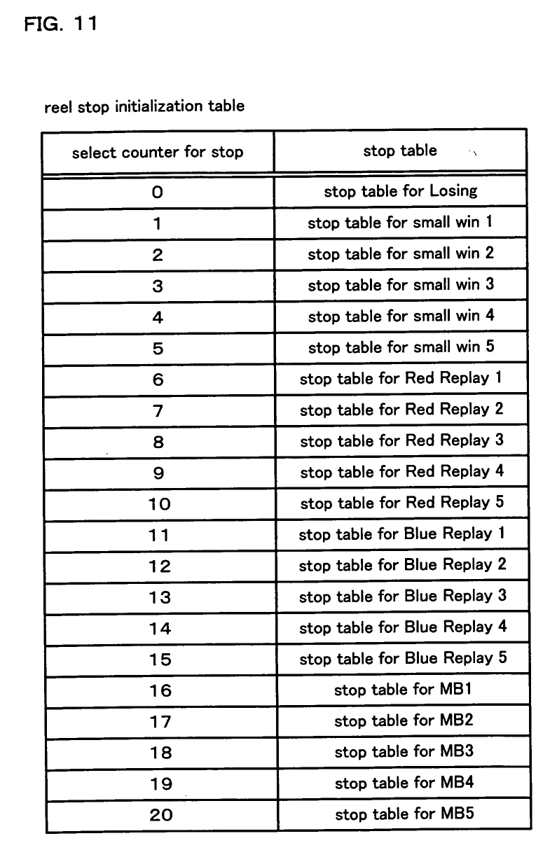

In the followings, a reel stop initialization table is described with reference to FIG. 11.

The reel stop initialization table defines a type of a stop table in correspondence with a select counter for stop. The select counter for stop is data for determining a stop table, which is basically identical to the winning number. Specifically, it is defined a stop table according to each of Losing, small win 1, small win 2, small win 3, small win 4, small win 5, red Replay 1, red Replay 2, red Replay 3, red Replay 4, red Replay 5, blue Replay 1, blue Replay 2, blue Replay 3, blue Replay 4, blue Replay 5, MB1, MB2, MB3, MB4, and MB5 in correspondence with each of the select counters for stop 0 to 20.

In the stop table, it is defined a combination of the symbols having the possibility to de displayed on the display windows 4L, 4C, and 4R. In particular, it is defined the number of the sliding symbols according to a symbol position (i.e., a symbol position where rotation of the reel stops, which is referred to as “stop starting position” corresponding to a symbol position counter of the corresponding reel when the stop operation is detected by the stop switch 7S. For example, in the case of the stop table for red Replay 1, it is defined the number of the sliding symbols for each symbol position as displayed for the symbol combination (following “red flower-red flower-red flower”) on the active line.

The number of sliding symbols is the number of symbols passing through the center line 8c within a period until the rotation of the corresponding reel is stopped after the stop operation is detected by the stop switch 7S. It is perceived by a value of the symbol position counter updated after the stop operation is detected by the stop switch 7S. In the base game mode according to the gaming machine 1, a stop control is done to the rotation of the reels 3L, 3C, and 3R within 190 msec after a signal is outputted by the stop switch 7S, and the maximum number of the sliding symbols is set to “4”.

For example, when the stop starting position is “0” and the number of sliding symbols determined is “4”, it is possible to stop the rotation of the reel such that the symbol corresponding to the symbol position of “4” is displayed on the center line 8c. Like this, the control for stopping the rotation of reel is referred to as “attraction-in”, which allows the symbol within a predetermined range (i.e., a range of the maximum number of sliding symbols ) from the stop starting position to be displayed on the center line 8. A position of the symbol which is attracted-in as the number of sliding symbols from the stop starting position and then stopped is referred to as “expected stop position”.

Herein, in the construction of the symbols arranged on the periphery of the reels 3L, 3C, and 3R of the present embodiment, it is possible to attract-in each of a 7, a red flower, a yellow flower, and a blue flower to the center line 8c within a range of 4 symbols from any stop starting position. That is, there does not occur so called the missing of the successive winning.

However, in the CB game mode, a rotation stop control is done to only the left reel 3L among three reels 3L, 3C, and 3R within 75 msec after a signal is outputted by the stop switch 7S, and the maximum number of the sliding symbols is set to “1”. Meanwhile, with regard to the other center reel 3C and the right reel 3R, similar to the base game mode, the maximum number of the sliding symbols is set to “4”.

As a result, since the number of possible attraction-in symbols is reduced at the CB game mode as compared to the base game mode, it is required for a player to have a more skillful technique. However, as described above, in the CB game mode, the complex win should be determined as an internal win so that it is possible to display, on the center line 8c, a combination of the symbols according to any one of the small win 1, the small win 2, the small win 3, the small win 4, and the small win 5, depending upon a timing of performing the stop operation. Accordingly, although in the case of the CB game mode, a technique intervening feature is higher than that in the base game mode, it is possible to establish a desired winning with a skill, which is advantageous to a player, thereby making it possible to raise the player's expectation.

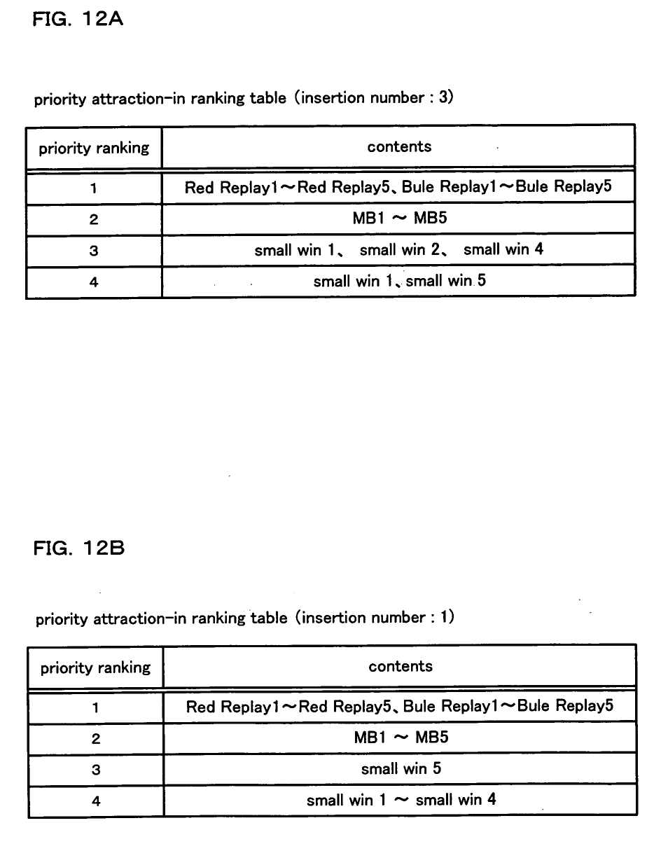

Next, a priority ranking table will be described with reference to FIGS. 12A and 12B.

In the priority ranking table, it is defined rankings in which the attraction-in is preferentially carried out between the types of the internal win (or types of symbol). The priority ranking table is defined by the insertion number.

FIG. 12A shows a priority ranking table for insertion number 3, which table is referred when the insertion number is 3. In the priority ranking table for insertion number 3, the priority rankings 1 to 4 are defined such that “red Replay 1 to red Replay 5, and blue Replay 1 to blue Replay 5”, “MB1 to MB5”, “small win 1, small win 2, and small win 4”, and “small win 3 and small win 5” are arranged in order from the higher priority rankings. Like this, the priority ranking table is grouped with kinds of internal wins and defined with one priority ranking. The priority rankings between the respective grouped internal wins are the same each other.

When two or more types of internal wins are determined referring to the priority ranking table, it is determined which type of internal win will have priority. That is, the stop table described above is merely initially determined so that the number of the sliding symbols is determined while referring also to the internal win and the priority ranking table. For example, when MB1 is carried over, although if it is determined a winning number 0 (i.e., small win 1), the above stop table for small win 1 is determined, an attraction-in of the symbol according to MB1 having higher priority is preferentially performed.

FIG. 12B shows a priority ranking table for insertion number 1, which table is referred when the insertion number is 1. In the priority ranking table for insertion number 1, the priority rankings 1 to 4 are defined such that “red Replay 1 to red Replay 5, and blue Replay 1 to blue Replay 5”, “MB1 to MB5”, “small win 5”, and “small win 1 to small win 4” are arranged in order from the higher priority rankings.

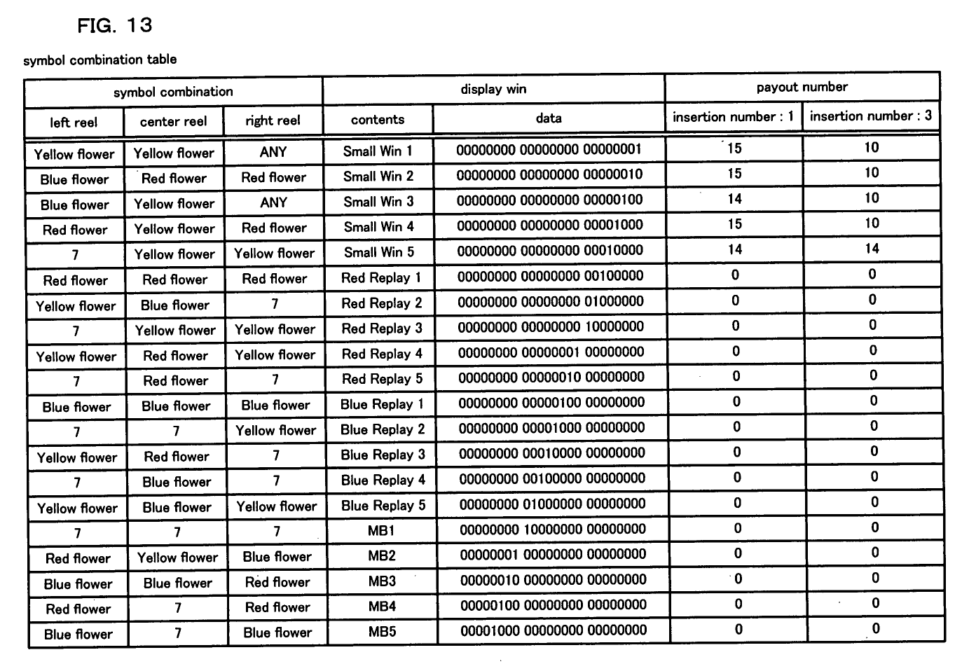

Herein, the priority ranking table is defined with the priority rankings in order of higher privilege provided to a player, excluding “red Replay 1 to red Replay 5, and blue Replay 1 to blue Replay 5” (See following FIG. 13). As will be described in detail later, when the insertion numbers are 3 and 1, respectively, the quantity of the privilege (more particularly, the payout number) according to small win 1 to small win 5 is different from each other. Accordingly, in the stop table for insertion number 3 and the stop table for insertion number 1, a method for defining the priority rankings for the types of small win is different. Meanwhile, it is grouped the internal wins having the same privilege and in which one priority ranking is defined.

In the followings, a symbol combination table will be described with reference to FIG. 13.

The symbol combination table is defined with a combination of the symbols according to a win, and a display win and the payout number thereof. The display win is shown in 3 byte data as in the case of data indicative of the internal win as described before. For example, data indicative of MB1 is displayed with ON of bit 15.

If it is displayed, on the center line 8c, a combination of the symbols according to the small win 1, “yellow flower-yellow flower-ANY (here, “ANY” means any type of symbols)”, that is, if the yellow flower (symbol 63) of the left reel 3L is displayed in the middle of the left display window 4L, and the yellow flower of the center reel 3C is displayed in the middle of the center display window 4C, the display win is determined as the small win 1, irrespective of the type of the symbol displayed in the middle of the other right display window 4R. The payout number is determined as 15 and 10 at the insertion numbers 1 and 3, respectively.

If it is displayed, on the center line 8c, a combination of the symbols according to the small win 2, “blue flower-red flower-red flower”, that is, if the blue flower (symbol 64) of the left reel 3L, the red flower (symbol 62) of the center reel 3C, and the red flower of the right reel 3R are displayed in the middle of the respective display windows 4L, 4C, and 4R, the display win is determined as the small win 2. The payout number is determined as 15 and 10 at the insertion numbers 1 and 3, respectively.

If it is displayed, on the center line 8c, a combination of the symbols according to the small win 3, “blue flower-yellow flower-ANY”, that is, if the blue of the left reel 3L is displayed in the middle of the left display window 4L, and the yellow flower of the center reel 3C is displayed in the middle of the center display window 4C, the display win is determined as the small win 3, irrespective of the type of the symbol displayed in the middle of the other right display window 4R. The payout number is determined as 14 and 10 at the insertion numbers 1 and 3, respectively.

If it is displayed, on the center line 8c, a combination of the symbols according to the small win 4, “red flower-yellow flower-red flower”, that is, if the red flower of the left reel 3L, the yellow flower of the center reel 3C, and the red flower of the right reel 3R are displayed in the middle of the respective display windows 4L, 4C, and 4R, the display win is determined as the small win 4. The payout number is determined as 15 and 10 at the insertion numbers 1 and 3, respectively.

If it is displayed, on the center line 8c, a combination of the symbols according to the small win 5, “7-yellow flower-yellow flower”, that is, if the 7 (symbol 61) of the left reel 3L, the yellow flower of the center reel 3C, and the yellow flower of the right reel 3R are displayed in the middle of the respective display windows 4L, 4C, and 4R, the display win is determined as the small win 5. The payout number is determined in common as 14 at the insertion numbers 1 and 3.

If it is displayed, on the center line 8c, a combination of the symbols according to the red Replay 1, “red flower-red flower-red flower”, that is, if the red flowers of the respective reels 3L, 3C, and 3R are displayed in the middle of the respective display windows 4L, 4C, and 4R, the display win is determined as the red Replay 1.

If it is displayed, on the center line 8c, a combination of the symbols according to the red Replay 2, “yellow flower-blue flower-7”, that is, if the yellow flower of the left reel 3L, the blue flower of the center reel 3C, and 7 of the right reel 3R are displayed in the middle of the respective display windows 4L, 4C, and 4R, the display win is determined as the red Replay 2.

Herein, on the peripheries of the left, center, and right reels 3L, 3C, and 3R, the red flower just after the yellow flower, the red flower just after the blue flower, and the red flower just after 7 are respectively arranged. Accordingly, when it is displayed, on the center line 8c, a combination of the symbols according to the red Replay 2, “yellow flower-blue flower-7”, a combination of the symbols, “red flower-red flower-red flower”, is displayed on the top line 8b, in which three red flowers are arranged in parallel.

If it is displayed, on the center line 8c, a combination of the symbols according to the red Replay 3, “7-yellow flower-yellow flower”, that is, if the 7 of the left reel 3L, the yellow flower of the center reel 3C, and yellow flower of the right reel 3R are displayed in the middle of the respective display windows 4L, 4C, and 4R, the display win is determined as the red Replay 3.

Herein, on the peripheries of the left, center, and right reels 3L, 3C, and 3R, the red flower just before 7, the red flower just before the yellow flower, and the red flower just before the yellow flower are respectively arranged. Accordingly, when it is displayed, on the center line 8c, a combination of the symbols according to the red Replay 3, “7-yellow flower-yellow flower”, a combination of the symbols, “red flower-red flower-red flower”, is displayed on the bottom line 8d, in which three red flowers are arranged in parallel.

If it is displayed, on the center line 8c, a combination of the symbols according to the red Replay 4, “yellow flower-red flower-yellow flower”, that is, if the yellow flower of the left reel 3L, the red flower of the center reel 3C, and yellow flower of the right reel 3R are displayed in the middle of the respective display windows 4L, 4C, and 4R, the display win is determined as the red Replay 4.

Herein, on the peripheries of the left and right reels 3L and 3R, the red flower just after the yellow flower, and the red flower just before the yellow flower are respectively arranged. Accordingly, when it is displayed, on the center line 8c, a combination of the symbols according to the red Replay 4, “yellow flower-red flower-yellow flower”, a combination of the symbols, “red flower-red flower-red flower”, is displayed on the cross down line 8e, in which three red flowers are arranged in parallel.

If it is displayed, on the center line 8c, a combination of the symbols according to the red Replay 5, “7-red flower-7”, that is, if 7 of the left reel 3L, the red flower of the center reel 3C, and 7 of the right reel 3R are displayed in the middle of the respective display windows 4L, 4C, and 4R, the display win is determined as the red Replay 5.

Herein, on the peripheries of the left and right reels 3L and 3R, the red flower just before 7, and the red flower just after 7 are respectively arranged. Accordingly, when it is displayed, on the center line 8c, a combination of the symbols according to the red Replay 5, “7-red flower-7”, a combination of the symbols, “red flower-red flower-red flower”, is displayed on the cross up line 8a, in which three red flowers are arranged in parallel.

If it is displayed, on the center line 8c, a combination of the symbols according to the blue Replay 1, “blue flower-blue flower-blue flower”, that is, if the blue flowers of the respective reels 3L, 3C, and 3R are displayed in the middle of the respective display windows 4L, 4C, and 4R, the display win is determined as the blue Replay 1.

If it is displayed, on the center line 8c, a combination of the symbols according to the blue Replay 2, “7-7-yellow flower”, that is, if 7 of the left reel 3L, 7 of the center reel 3C, and the yellow flower of the right reel -3R are displayed in the middle of the respective display windows 4L, 4C, and 4R, the display win is determined as the blue Replay 2.

Herein, on the peripheries of the left, center, and right reels 3L, 3C, and 3R, the blue flower just after 7, the blue flower just after 7, and the blue flower just after the yellow flower are respectively arranged. Accordingly, when it is displayed, on the center line 8c, a combination of the symbols according to the blue Replay 2, “7-7-yellow flower”, a combination of the symbols, “blue flower-blue flower-blue flower”, is displayed on the top line 8b, in which three blue flowers are arranged in parallel.

If it is displayed, on the center line 8c, a combination of the symbols according to the blue Replay 3, “yellow flower-red flower-7”, that is, if the yellow flower of the left reel 3L, the red flower of the center reel 3C, and 7 of the right reel 3R are displayed in the middle of the respective display windows 4L, 4C, and 4R, the display win is determined as the blue Replay 3.

Herein, on the peripheries of the left, center, and right reels 3L, 3C, and 3R, the blue flower just before the yellow flower, the blue flower just before the red flower, and the blue flower just before 7 are respectively arranged. Accordingly, when it is displayed, on the center line 8c, a combination of the symbols according to the blue Replay 3, “yellow flower-red flower-7”, a combination of the symbols, “blue flower-blue flower-blue flower”, is displayed on the bottom line 8d, in which three blue flowers are arranged in parallel.

If it is displayed, on the center line 8c, a combination of the symbols according to the blue Replay 4, “7-blue flower-7”, that is, if 7 of the left reel 3L, the blue flower of the center reel 3C, and 7 of the right reel 3R are displayed in the middle of the respective display windows 4L, 4C, and 4R, the display win is determined as the blue Replay 4.

Herein, on the peripheries of the left and right reels 3L and 3R, the blue flower just after 7, and the blue flower just before 7 are respectively arranged. Accordingly, when it is displayed, on the center line 8c, a combination of the symbols according to the blue Replay 4, “7-blue flower-7”, a combination of the symbols, “blue flower-blue flower-blue flower”, is displayed on the cross down line 8e, in which three blue flowers are arranged in parallel.

If it is displayed, on the center line 8c, a combination of the symbols according to the blue Replay 5, “yellow flower-blue flower-yellow flower”, that is, if the yellow flower of the left reel 3L, the blue flower of the center reel 3C, and the yellow flower of the right reel 3R are displayed in the middle of the respective display windows 4L, 4C, and 4R, the display win is determined as the blue Replay 5.

Herein, on the peripheries of the left and right reels 3L and 3R, the blue flower just before the yellow flower, and the blue flower just after the yellow flower are respectively arranged. Accordingly, when it is displayed, on the center line 8c, a combination of the symbols according to the blue Replay 5, yellow flower-blue flower-yellow flowery, a combination of the symbols, “blue flower-blue flower-blue flower”, is displayed on the cross up line 8a, in which three blue flowers are arranged in parallel.

When any one of red Replay 1 to red Replay 5 is determined, a replay is performed at the next unit game. That is, at the next game, it is automatically inserted the medals with the same number as the insertion number of the unit game in which Replay is established, without being based on the insertion operation by the player. Accordingly, the player can have the next unit game without consuming a medal.

If it is displayed, on the center line 8c, a combination of the symbols according to the MB1, “7-7-7”, that is, if 7s of the respective reels 3L, 3C, and 3R are displayed in the middle of the respective display windows 4L, 4C, and 4R, the display win is determined as the MB1.

If it is displayed, on the center line 8c, a combination of the symbols according to the MB2, “red flower-yellow flower-blue flower”, that is, if the red flower of the left reel 3L, the yellow flower of the center reel 3C, and the blue flower of the right reel 3R are displayed in the middle of the respective display windows 4L, 4C, and 4R, the display win is determined as the MB2.

Herein, on the peripheries of the left, center, and right reels 3L, 3C, and 3R, 7 just after the red flower, 7 just after the yellow flower, and 7 just after the blue flower are respectively arranged. Accordingly, when it is displayed, on the center line 8c, a combination of the symbols according to the MB2, “7 7-yellow flower”, a combination of the symbols, “7-7-7”, is displayed on the top line 8b, in which three 7s are arranged in parallel.

If it is displayed, on the center line 8c,- a combination of the symbols according to the MB3, “blue flower-blue flower-red flower”, that is, if the blue flower of the left reel 3L, the blue flower of the center reel 3C, and the red flower of the right reel 3R are displayed in the middle of the respective display windows 4L, 4C, and 4R, the display win is determined as the MB3.

Herein, on the peripheries of the left, center, and right reels 3L, 3C, and 3R, 7 just before the blue flower, 7 just before the blue flower, and 7 just before the red flower are respectively arranged. Accordingly, when it is displayed, on the center line 8c, a combination of the symbols according to the MB3, “blue flower-blue flower-red flower”, a combination of the symbols, “7-7-7”, is displayed on the bottom line 8d, in which three 7s are arranged in parallel.

If it is displayed, on the center line 8c, a combination of the symbols according to the MB4, “red flower-7-red flower”, that is, if the red flower of the left reel 3L, the 7 of the center reel 3C, and the red flower of the right reel 3R are displayed in the middle of the respective display windows 4L, 4C, and 4R, the display win is determined as the MB4.

Herein, on the peripheries of the left and right reels 3L and 3R, 7 just after the red flower, and 7 just before the red flower are respectively arranged. Accordingly, when it is displayed, on the center line 8c, a combination of the symbols according to the MB4, “red flower-7-red flower”, a combination of the symbols, “7-7-7”, is displayed on the cross down line 8e, in which three 7s are arranged in parallel.

If it is displayed, on the center line 8c, a combination of the symbols according to the MB5, “blue flower-7-blue flower”, that is, if the blue flower of the left reel 3L, the 7 of the center reel 3C, and the blue flower of the right reel 3R are displayed in the middle of the respective display windows 4L, 4C, and 4R, the display win is determined as the MB5.

Herein, on the peripheries of the left and right reels 3L and 3R, the 7 just before the blue flower, and the 7 just after the blue flower are respectively arranged. Accordingly, when it is displayed, on the center line 8c, a combination of the symbols according to the MB5, “blue flower-7-blue flower”, a combination of the symbols, “7-7-7”, is displayed on the cross up line 8a, in which three 7s are arranged in parallel.

When any one of above MB1 to MB5 is determined, a flag under MB operation, which will be described later, is updated to ON to start the operation of the MB.

If it is displayed other symbol combination than those of the small win, the red Replay, the blue Replay, or the MB, the display win is determined to be a losing. Herein, the small win is according to the payout of the gaming medium such as a medal. The Replay is according to the operation of the replay. The MB is according to the operation of the advantageous game mode (e.g., CB game mode).

In the followings, a table on bonus operation is described with reference to FIG. 15.

The table on bonus operation defines data stored in a predetermined area of the RAM 33. When MB operates, the flag under MB operation of the RAM 33 becomes ON, 253 is stored in a bonus end number. The bonus end number counter is data for counting the payout number under the operation of MB and the determined payout number is subtracted every unit game. When the bonus end number counter is updated to 0, the operation of MB is ended.

In the followings, it is described an internal win storing area of the RAM 33 of the main control circuit 71, with reference to FIG. 15.

If an internal win is determined by the determination table for internal win, it is stored in an internal win storing area. The internal win storing area consists of 3 byte and corresponds to the data of the internal win described above. In other words, the bit string corresponding to the type of the determined internal win becomes ON. Meanwhile, in the case of Losing, all bits become 0. Additionally, when two or more types of internal wins are determined, the bit corresponding to each type becomes ON. For example, when MB1 and Red Replay 4 are determined, bits 8 and 15 of the internal win storing area becomes ON.

In the mean time, when a display win is determined by the symbol combination table, the data thereof is stored in a display win storing area of the RAM 33. The display win storing area has the same data structure as that of the internal win storing area.

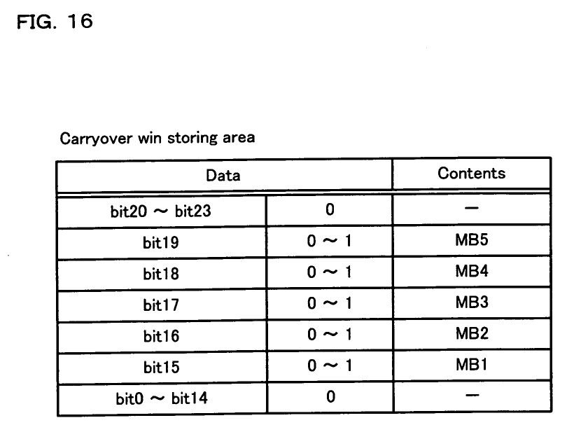

In the followings, it is described an internal carryover win storing area of the RAM 33 of the main control circuit 71, with reference to FIG. 16.

If any one of MB1 to MB5 is determined as an internal win by the determination table for internal win, it is stored in an internal carryover win storing area. The internal carryover win storing area consists of 3 byte and corresponds to the data structure of the above described internal win. That is, bit corresponding to the type of the determined MB becomes ON. Meanwhile, when there is no carryover win, all bits become ON. For example, bit 15 becomes ON when MB1 is determined, and bit 19 becomes ON when MB5 is determined.

When the MB operation starts, the data of the internal carryover win storing area is cleared. In other words, in the gaming machine 1, if MB is determined, a combination of the symbols according to MB is displayed and the data thereof is stored during a period of until the MB operation starts. In the mean time, since the carryover win is determined on the basis of the internal win, it can be said that the carryover win is a subordinate concept of the internal win.

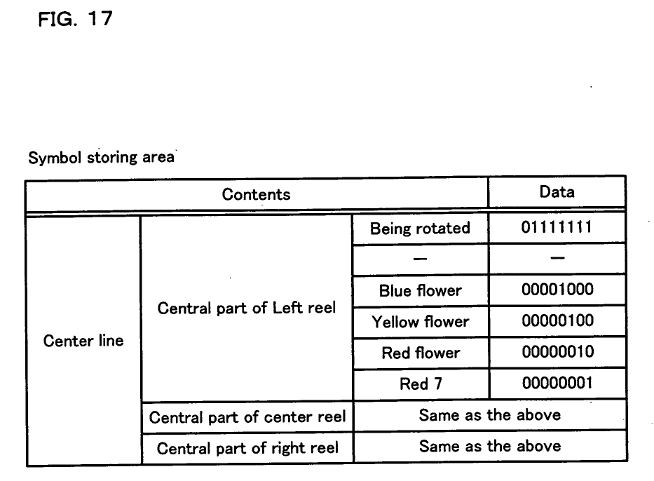

In the followings, it is described a symbol storing area of the RAM 33 of the main control circuit 71 with reference to FIG. 17.

The data representing types of the symbols displayed in the respective display windows 4L, 4C, 4R is stored in a symbol storing area. Specifically, a type of a symbol located in the central part of the left display window 4L, a type of a symbol located in the central part of the center display window 4C and a type of a symbol located in the central part of the right display window 4R are respectively stored therein. The types of the symbols stored in the symbol storing area are specified based on the symbol counter and the symbol arrangement table. For example, if the symbol counter of the stopped reel is “0”, the symbol in position of “0” is specified based on the symbol arrangement table and stored in the symbol storing area. In the gaming machine 1, the win is determined based on the symbol storing area and the above described symbol combination table.

The data stored in each of the symbol storing areas consists of 1 byte and corresponds to the data representing the type of the symbol defined in the symbol arrangement table described above. The data representing that the reel is being rotated may be stored in the symbol storing area, which data is expressed by “0111111”.

Meanwhile, the symbol storing area is not limited to data indicative of the type of the symbol displayed on the center line 8c, but may store data indicative of the type of the symbols displayed on the top line 8b, the bottom line 8d, the cross-up line 8a, and the cross-down line 8e, respectively.

Hereinafter, a control carried out by the CPU 31 of the main control circuit 71 is described with reference to flow charts shown in FIGS. 18 to 27.

First, a RESET-intervention process is described with reference to FIG. 18, which is executed by the CPU 31 of the main control circuit 71. When power is inputted and a voltage is applied to a reset terminal, the CPU 31 generates a RESET-intervention and sequentially carries out a RESET-intervention process which is stored in the ROM 32, on the basis of the generation of the RESET-intervention.

When the power is inputted, the CPU 31 first executes an initialization process (step S1). In the initialization process, it is carried out a process of restoring an execution address or register data stored in the RAM 33 when the power is cut off.

Next, the CPU 31 clears an indicated storing area (step S2). Thereby, the data stored in the internal win storing area, etc. of the RAM 33 is cleared.

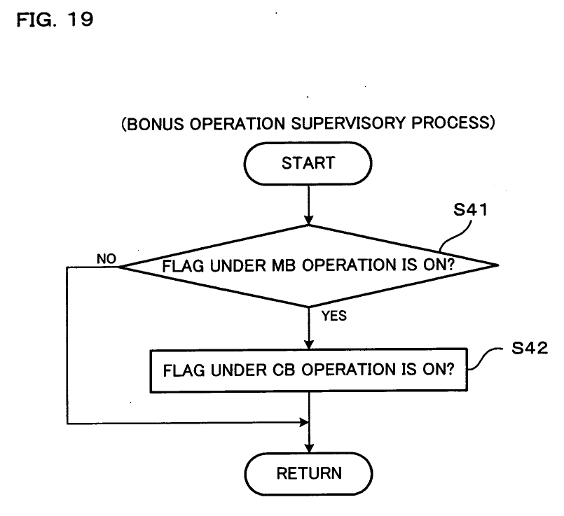

Then, the CPU 21 performs a bonus operation supervisory process, which will be described later with reference to FIG. 19 (step S3). In this bonus operation supervisory process, when MB is being operated, it is performed to turn ON a flag on CB operation.

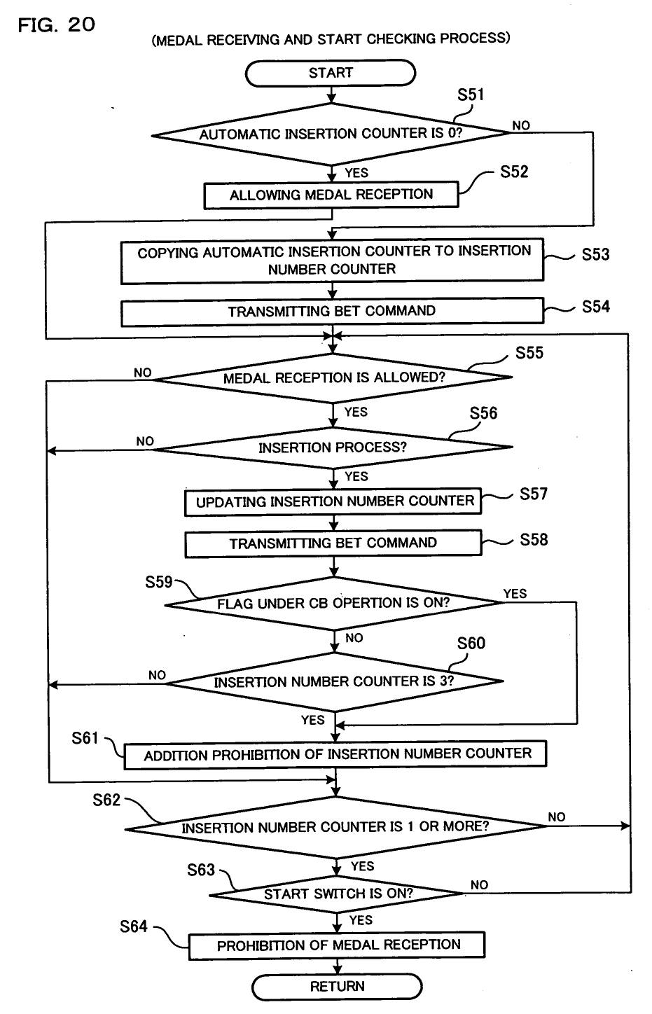

Next, the CPU 31 executes a medal receiving and start checking process which will be described later with reference to FIG. 20 (step S4). In the medal receiving and start checking process, the insertion number counter is updated through the check on the medal sensor 22S, the BET switches 11S, 12S, 13S and the like, or the input of the start switch 6S is checked.

Next, the CPU 31 samples and stores a random number in the random number storing area (step S5). Specifically, the CPU 31 samples a random number for lottery by the random number generating circuit 36 and the sampling circuit 37, which is used in the internal lottery process and the like, and stores it in the random number storing area of the RAM 33.

Next, the CPU 31 executes a game mode supervisory process (step S6). Specifically, the CPU stores an identifier (so-called flag) representing the CB game mode in the RAM 33 if the flag under CB operation is ON and stores an identifier representing the base game mode in the RAM 33 if the flag under CB operation is OFF.

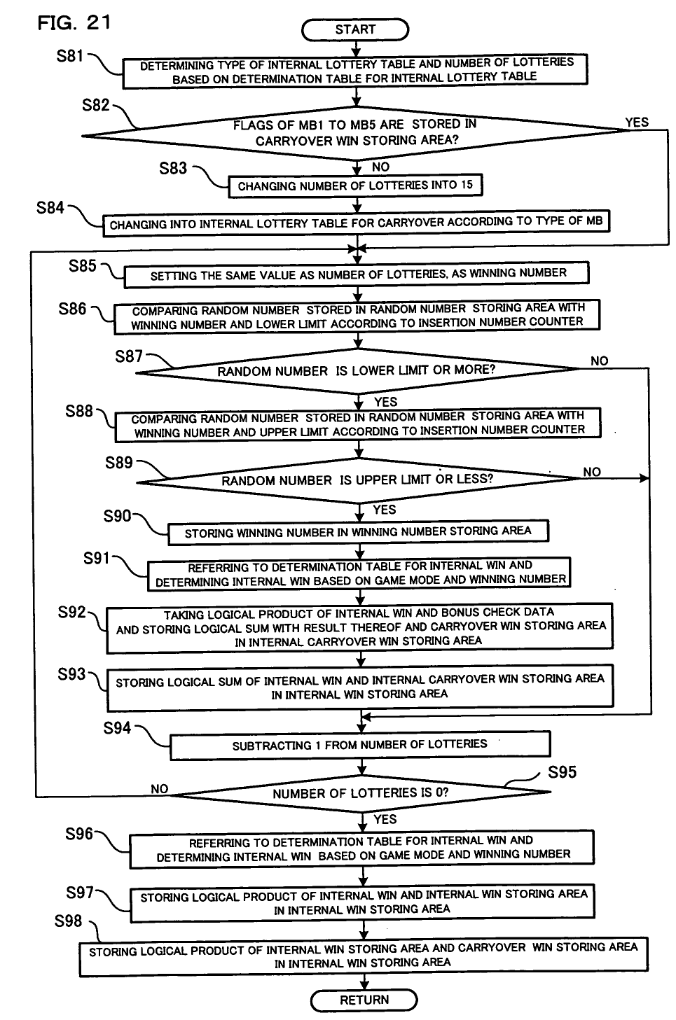

Next, the CPU 31 performs an internal lottery process which will be described later with reference to FIG. 21 (step S7). In the internal lottery process, it is carried out a process of determining an internal win and the like.

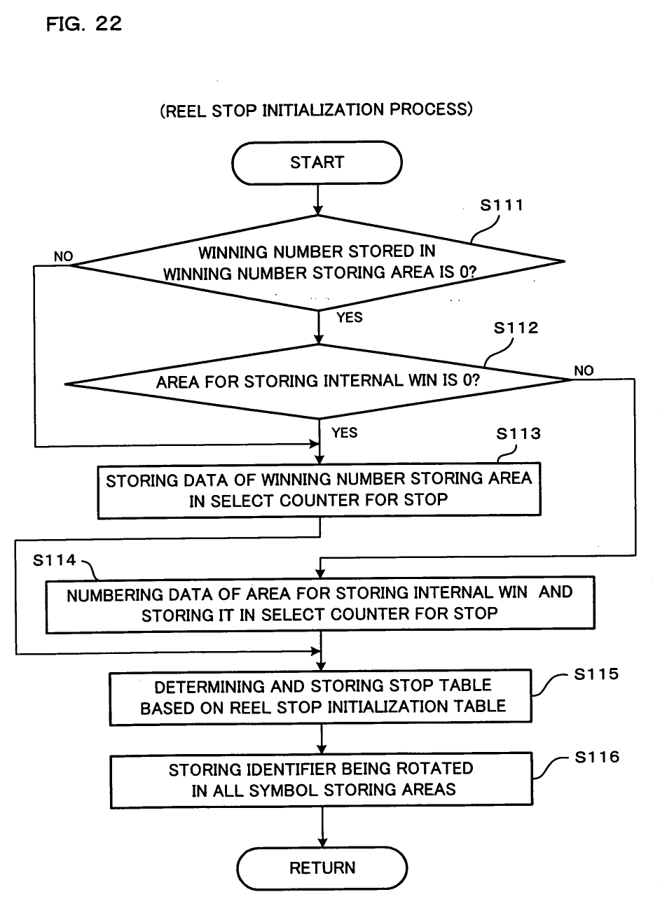

Next, the CPU 31 carries out a reel stop initialization process which will be described later with reference to FIG. 22 (step S8). In the reel stop initialization process, it is performed a process of determining a stop table based on the winning number and the reel stop setting table.

Next, the CPU 31 transmits the start command to the sub-control circuit 72 (step S9). The start command contains data such as internal win, game mode and the like.

Next, the CPU 31 determines whether 4.1 seconds have elapsed after the previous rotation start of the reel (step S10). When it is determined that 4.1 seconds have not elapsed, the CPU 31 consumes the waiting time (step S11). Specifically, the CPU 31 carries out a waiting process without performing the subsequent processes until 4.1 seconds have elapsed.

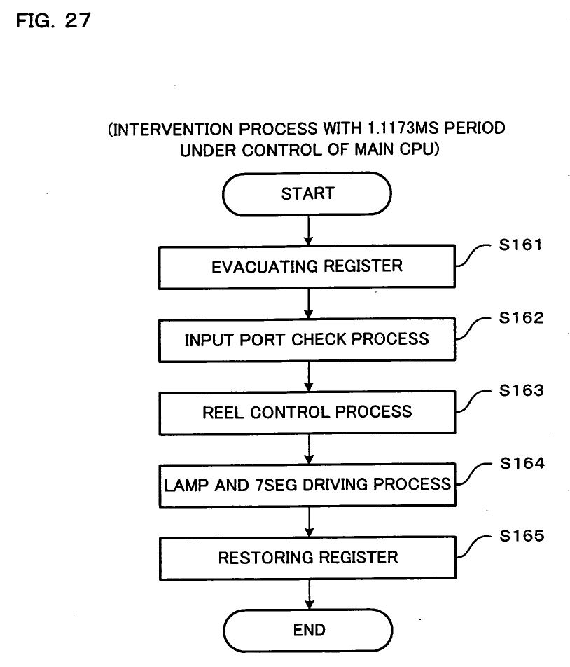

When the step S10 determines that 4.1 seconds have elapsed, or after the process in the step S11, the CPU 31 requests rotation start of all the reels (step S12). When it is requested the rotation of all the reels, a process of starting to rotate the reels is carried out in an intervention process (see FIG. 27) which will be described later.

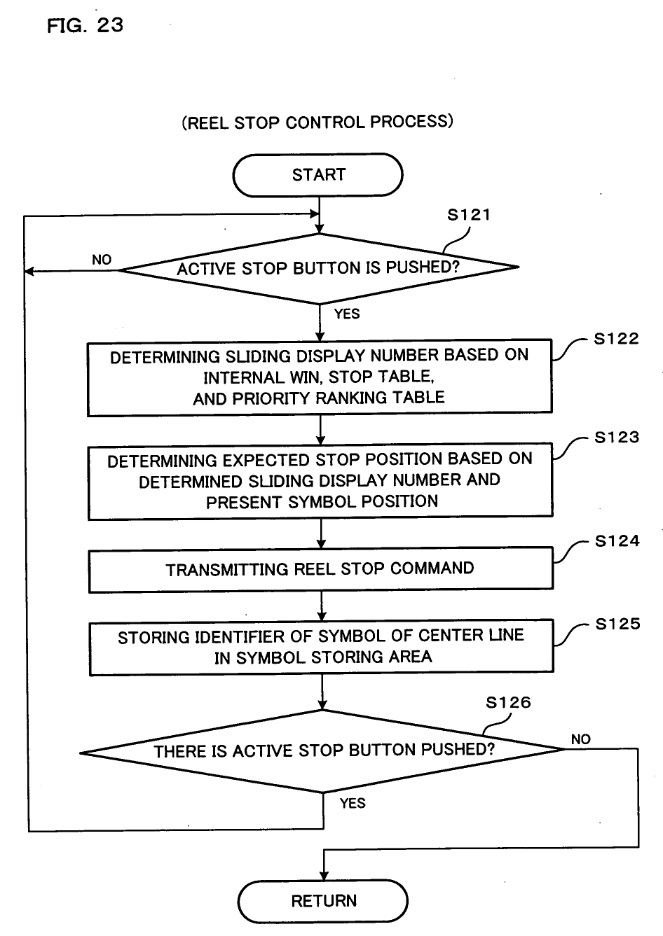

Next, the CPU 31 executes a reel stop control process which will be described later with reference to FIG. 23 (step S13). In the reel stop control process, it is carried out a process of determining the number of sliding symbols and the expected stop position, and of stopping the reel rotation based on the corresponding expected stop position.

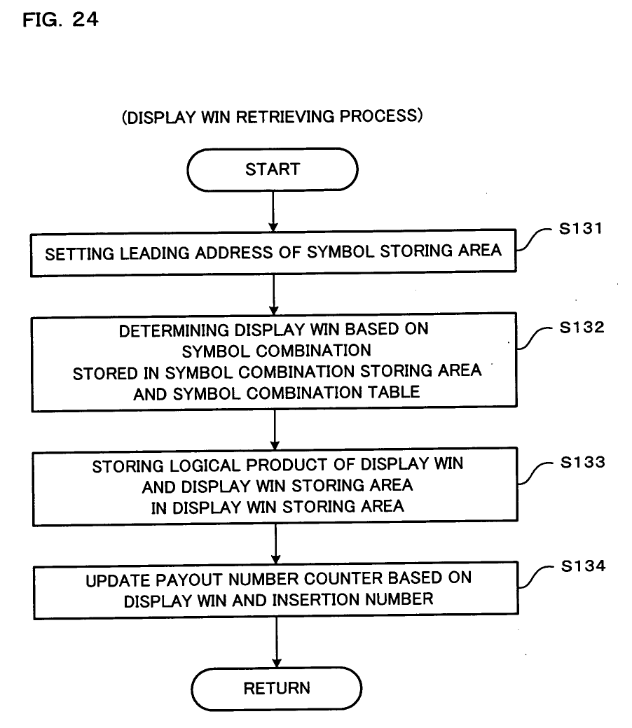

Next, the CPU 31 carries out a display win retrieving process which will be described later with reference to FIG. 24 (step S14). In this display win retrieving process, it is carried out a process of determining a display win and the payout number based on the symbol storing area and the symbol combination table.

Next, the CPU 31 transmits a display win command to the sub-control circuit 72 (step S15). The display win command contains data such as display win made and the like.

Next, the CPU 31 carries out a medal payout process (step S16). Specifically, the CPU 31 controls the hopper 40 or updates the credit counter, based on the payout number determined in the step S14.

Next, the CPU 31 updates the bonus end number counter based on the payout number (step S17). Specifically, when the bonus end number counter is 1 or more, a subtraction is made by the payout number from the corresponding counter.

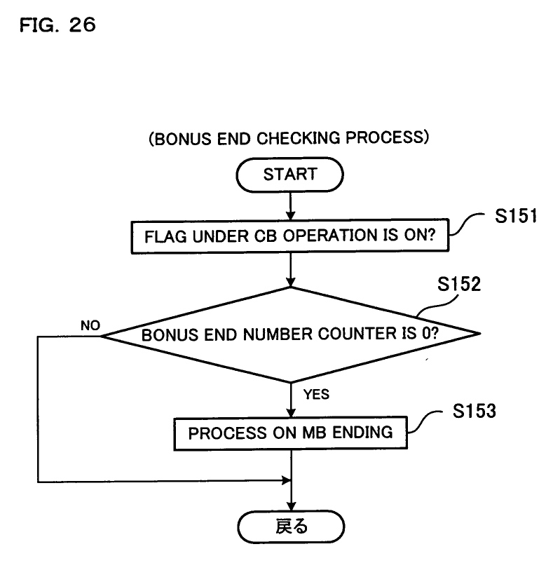

Next, the CPU 31 determines whether the flag under MB operation is ON or not (step S18). If it is determined that the flag under MB operation is ON, the CPU 31 carries out a bonus end checking process which will be described later with reference to FIG. 26 (step S19). In the bonus end checking process, it is carried out a process of ending the MB operation, based on the update result of the bonus end number counter.

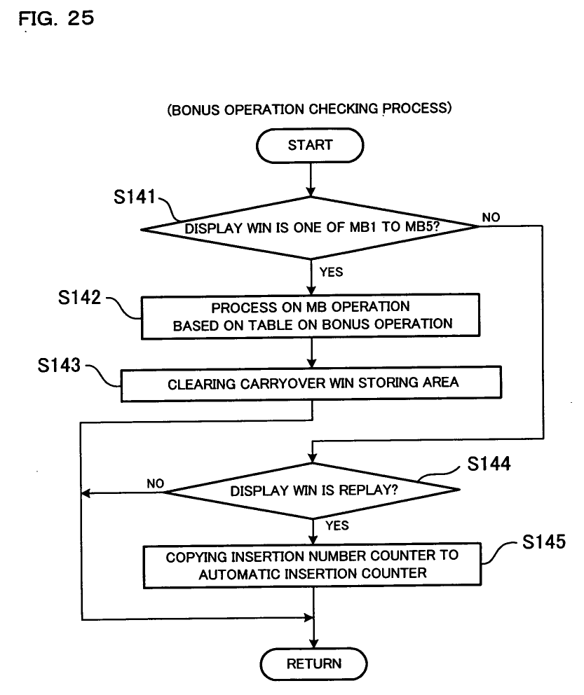

When it is determined that the flag under MB operation is not ON in the step of S18, or after the process in the step S19, the CPU 31 carries out a bonus operation checking process which will be described with reference to FIG. 25 (step S20). In the bonus operation checking process, it is carried out a process of starting an operation of bonus when a display win is MB.

Like this, the CPU 31 executes the steps S2 to S20 as processes in a unit game. When the step S20 is over, the CPU proceeds to the step S2 so as to carry out the processes in a next unit game.

Next, the bonus operation supervisory process will be described with reference to FIG. 19.

First, the CPU 31 determines whether the flag under MP operation is ON (step S41). If it is determined that the flag under MB operation is not ON, the CPU 31 terminates the bonus operation supervisory process and moves to a step S4 of FIG. 18.

If the flag under MB operation is determined ON in the step S41, the CPU 31 makes the flag under CB operation ON (step S42). When this process is terminated, the CPU terminates the bonus operation supervisory process and moves to the step S4 of FIG. 18. Like this, in the gaming machine 1, if the flag under MB operation is ON, it is carried out a CB operation, and the CB operation is continuously performed during MB operation.

In the followings, a medal receiving and start checking process is described with reference to FIG. 20.

First, the CPU 31 determines whether an automatic insertion counter is 0 or not (step S51). When it is determined that the automatic insertion counter is 0, the CPU 31 allows the reception of medal (step S52). The automatic insertion counter is data for identifying whether Replay has been determined in the previous unit game.

When it is determined that the automatic insertion number is not 0 in the step S51, the CPU 31 copies the automatic insertion number to the insertion number counter (step S53). The insertion number counter is data for counting the insertion number.

Next, the CPU 31 transmits a BET command to the sub-control circuit 72 (step S54). The BET command includes data of the insertion number and the like.

After the process in the step S54 or the process in the step S52, the CPU 51 determines whether the reception of medal is allowed or not (step S55). When it is determined that the reception of medal is allowed, the CPU 31 determines whether it is under insertion process (step S56). Specifically, the CPU 31 determines that it is under insertion process when the medal sensor 22S or the BET switches 11S, 12S, 13S is ON. When the BET switches 11S, 12S, 13S are ON, the CPU 31 calculates a value to be added to the insertion number counter, based on types of the BET switches 11S, 12S, 13S, the insertion number counter and a credit counter. The credit counter is data for counting the number of medals credited.

When it is determined as the insertion process in the step S56, the CPU 31 updates the insertion number counter (step S57). Meanwhile, in this process, when it is prohibited the addition of the insertion number counter, the CPU 31 updates the credit counter, instead of the insertion number counter.

Next, the CPU 31 transmits the BET command to the sub-control circuit 72 (step S58). The CPU 31 determines whether the flag under CB operation is ON or not (step S59). When it is determined that the flag under CB operation is not ON, the CPU 31 determines whether the insertion number counter is 3 or not (step S60).

When it is determined that the insertion number counter is 3 in the step S60, or when it is determined that the flag under CB operation is ON in the step S59, the CPU prohibits the addition of the insertion number counter (step S61).

After the process in the step S61, when it is determined that the reception of medal is not allowed in the step S55, when it is determined that it is not under insertion process in the step S56 or when it is determined that the insertion number counter is not 3 in the step S60, the CPU 31 determines whether the insertion number counter is 1 or more (step S62). If it is determined that the insertion number counter is 0, the CPU 31 proceeds to the step S55.

When it is determined that the insertion number counter is 1 or more in the step S62, the CPU 31 determines whether the start switch 6S is ON or not (step S63). When it is determined that the start switch 6S is not ON, the CPU 31 proceeds to the step S55.

When it is determined that the start switch 6S is ON in the step S63, the CPU 31 prohibits the reception of medal (step S64). When this process is over, the CPU terminates the medal receiving and start checking process and proceeds to the step S5 in FIG. 18.

In the followings, an internal lottery process is described with reference to FIG. 21.

First, the CPU 31 determines a type of the internal lottery table and the number of lotteries, based on the game mode and the determination table for internal lottery table (step S81).

Next, the CPU 31 determines whether the flag of any one of MB1 to MB5 is stored in the internal carryover win storing area (step S82). When it is determined that the flag of any one of MB1 to MB5 is stored in the internal carryover win storing area, the CPU 31 changes the number of lotteries into 15 (step S83). In other words, when there is a carryover win in the base game mode, the number of lotteries determined to be 20 times is changed to 15 times and MB1 to MB5 are not duplicately determined.

Next, the CPU 31 performs a process to change a table into an internal lottery table for carryover (step S84). For example, in the case of MB1, the table is changed into the internal lottery table for MB1 carryover, in the case of MB2 or MB3, the table is changed into the internal lottery table for MB2 or MB3 carryover, and in the case of MB4 or MB5, the table is changed into the internal lottery table for MB4 and MB5 carryover.

When it is determined that no flag of any one of MB1 to MB5 is stored in the internal carryover win storing area in the step S82, or after the process in the step S84, the CPU 31 sets the same value as the number of lotteries, as a winning number (step S85).

Next, the CPU 31 compares the random number stored in the random number storing area with the winning number and the lower limit according to the insertion number counter (step S86). Then, the CPU 31 determines whether the random number is the lower limit or more (step S87).

When it is determined that the random number is the lower limit or more in the step S87, the CPU 31 compares the random number stored in the random number storing area with the winning number and the upper limit according to the insertion number counter (step S88). Then, the CPU 31 determines whether the random number is the upper limit or less (step S89).

When it is determined that the random number is the upper limit or less in the step S89, the CPU 31 stores the set winning number in a winning number storing area (step S90). The winning number storing area has an initial value of 0 and is sequentially overwritten as this process is carried out. Since the winning numbers are retrieved in descending order from high value, when the winning number is duplicately determined, the smaller winning number is preferentially stored.

Next, the CPU 31 determines a game mode referring to the determination table for internal win, and an internal win based on the winning number (step S91).

Then, the CPU 31 takes a logical product of the determined internal win and bonus check data and stores a logical sum with a result thereof and the internal carryover win storing area in the carryover win storing area (step S92). Herein, the bonus check data is 3 byte data in which all of bit 15 to bit 19 corresponding to MB1 to MB5 are ON. When the internal win is any one of MB1 to MB5, the corresponding MB is stored in the carryover win storing area.

Next, the CPU 31 stores a logical sum of the internal win and the internal carryover win storing area in the internal win storing area (step S93). For example, in the case where the small win 1 is determined when MB1 is carried over, bits 15 and 0 of the internal win storing area become ON.

After the process in the step S93, when it is determined that the random number is not the lower limit or more in the step S87, or when it is determined that the random number is not the upper limit or less in the step S89, the CPU 31 subtracts 1 from the number of lotteries (step S94).

Next, the CPU 31 determines whether the number of lotteries is 0 or not (step S95). When it is determined that the number of lotteries is not 0, the CPU 31 proceeds to the step S85.

When it is determined that the number of lotteries is 0 in the step S95, the CPU 31 refers to the determination table for internal win to determine an internal win, based on the game mode and the winning number (step S96). In this process, in the case of the base game mode, the Losing is determined as an internal win based on the winning number 0, and in the case of CB game mode, a complex win is determined as an internal win based on the winning number 0.

Next, the CPU 31 stores a logical sum of the internal win and the internal win storing area in the internal win storing area (step S97). Next, the CPU 31 stores a logical product of the internal win storing area and the carryover win storing area in the internal win storing area (step S98). When this process is over, the CPU ends the internal lottery process and proceeds to the step SB in FIG. 18.

In the followings, a reel stop initialization process is described with reference to FIG. 22.

Next, the CPU 31 determines whether the winning number stored in the winning number storing area is 0 (step Sill). When it is determined that the winning number is 0, the CPU 31 determines whether the area for storing a win is 0 or not (step S112).

When it is determined that the winning number is not 0 in the step Sill, or when it is determined that the area for storing a win is 0 in the step S112, the CPU 31 stores the data of the winning number storing area in the select counter for stop (step S113).

When it is determined that the area for storing a win is not 0 in the step S112, the CPU 31 numbers the data of the area for storing a win and stores it in the select counter for stop (step S114). For example, when the data of the internal win storing area is MB1 (i.e., when bit 15 is ON), the CPU 31 stores 16, and in the case of MB5, it stores 20.

After the process in the step S113 or step S113, the CPU 31, based on the select counter for stop and the reel stop initialization table, determines the stop table and stores it in the RAM 33 (step S115).

Next, the CPU 31 stores the identifier being rotated in all the symbol storing areas (step S116). When this process is terminated, the CPU terminates the reel stop initialization process and proceeds to the step S9.

In the followings, a reel stop control process is described with reference to FIG. 23.

First, the CPU 31 determines whether an active stop button is pushed or not (step S121). When it is determined that the active stop button is not pushed, the CPU 31 repeats the process in the step S121. In the mean time, the CPU 31 may determine whether an automatic stop timer is 0, that is, whether a predetermined time (for example, 40 sec) has elapsed after the start switch 6S has been ON while determining whether the active stop button is pushed in order to carry out a so-called automatic stop.

When it is determined that the active stop button is pushed in the step S121, the CPU 31 invalidates the push operation of the corresponding stop button and determines the number of sliding symbols based on the internal win, the stop table, and the priority ranking table (step S122).

For example, as a case where it is determined two or more types of internal wins including the case where the complex win is determined, if there are symbol positions capable of attracting-in the symbols according to internal win (more specifically, the data stored in the internal win storing area) within a range of 4 symbols from the stop starting position, the difference up to the symbol with higher priority ranking is determined as the number of sliding symbols. For example, in the case where the winning number 6 (i.e., Red Replay 1) is won when the MB1 is carried over, if it has been retried a symbol position capable of attracting-in Red flower according to Red Replay 1 with higher priority ranking within a range of 4 symbols from the stop starting position, the difference up to the corresponding symbol position is determined as the number of sliding symbols. In the CB game mode, it is retrieved on whether there is a symbol position capable of attracting-in a symbol according to an internal win within a range of 1 symbol from the stop starting position for only the left reel 3L, and the number of sliding symbols is determined to any one of “0” and “1”.

Next, the CPU 31 determines an expected stop position based on the number of sliding symbols determined and the present symbol position (step S123). For example, when the number of sliding symbols determined is “2”, and the present symbol position is “19”, the expected stop position is determined to “0”. When the expected stop position is stored, it is performed a process to stop the rotation of the reel based on the corresponding expected stop position in an intervention process described later (See FIG. 27). Meanwhile, if one of the number of sliding symbols and the expected stop position is determined, the other is determined. Accordingly, it can be said that they have an equivalent relationship.

Next, the CPU 31 transmits a reel stop command to the sub-control circuit 72 (step S124). The reel stop command includes data of the type of the stopped reel, and the like.

Next, the CPU 31 stores an identifier of the symbol of the active center line 8c in the symbol storing area (step S125). For example, if the symbol counter of the stopped reel is “0”, the type of the symbol in position of “0” is stored in the symbol storing area referring to the symbol arrangement table.

Next, the CPU 31 determines whether there is the stop button activated for the push operation (step S126). When it is determined that there is the stop button activated for the push operation, the CPU 31 proceeds to the step S121, and when it is determined that there is no stop button effective for the push operation, the CPU terminates the reel stop control process and proceeds to the step S14 in FIG. 18.

In the followings, a display win retrieving process is described with reference to FIG. 24.

First, the CPU 31 sets a leading address of the symbol storing area (step S131). Then, the CPU 31 determines a display win based on a combination of the symbols stored in the symbol storing area, and the symbol combination table (step S132). Specifically, the CPU 31 performs a retrieval on whether the combination of the symbols displayed on the center line 8c and stored in the symbol storing area and the combination of all symbols defined in the symbol combination table match each other, thereby determining the display win.

Next, the CPU 31 stores a logical sum of the display win and the display win storing area in the display win storing area (step S133). Then, the CPU 31 determines the payout number based on the insertion number counter and the display win determined referring to the symbol combination table, and updates the payout number counter (step S134). When this process is terminated, the CPU terminates the display win retrieval process and proceeds to the step S15 of FIG. 18.

In the followings, a bonus operation checking process is described with reference to FIG. 25.

First, the CPU 31 determines whether the display win is one of MB1 to MB5 (step S141). When it is determined that the display win is one of MB1 to MB5, the CPU 31 carries out the process on RB operation, based on the table on bonus operation (step S142). Next, the CPU 31 clears the internal carryover win storing area (step S143). When this process is over, the CPU terminates the bonus operation checking process and then proceeds to the step S2 in FIG. 18.

When it is determined that the display win is not any one of MB1 to MB5 in the step S141, the CPU 31 determines whether the display win is Replay or not (step S144). When it is determined that the display win is not Replay, the CPU 31 terminates the bonus operation checking process and then proceeds to the step S2 in FIG. 18.

When it is determined that the display win is Replay, the CPU 31 copies the insertion number counter to the automatic insertion counter (step S145). When this process is over, the CPU terminates the bonus operation checking process and then proceeds to the step S2 in FIG. 18.

In the followings, a bonus end checking process is described with reference to FIG. 26.

First, the CPU 31 turns the flag under CN operation OFF (step S151). Next, the CPU 31 determines whether the bonus end number counter is 0 (step S152). When it is determined that the bonus end number counter is not 0, the CPU 31 terminates the bonus end checking process and proceeds to the step S20 of FIG. 18.

When it is determined that the bonus end number counter is 0 in the step S152, the CPU 31 carries out a process on MB ending (step S153). Specifically, the CPU 31 performs the clearing of the flag under MB operation and the bonus end number counter. When this process is over, the CPU terminates the bonus end checking process and then proceeds to the step S20 in FIG. 18.

In the followings, it is described an intervention process having a period of 1.1173 ms which is carried out under control of the CPU 31 of the main control circuit 71, with reference to FIG. 27.

First, the CPU 31 evacuates a register (step S162). Next, the CPU 31 checks an input port (step S162). Specifically, the CPU 31 checks signal inputs from each switch and the like.

Next, the CPU 31 carries out a reel control process (step S163). Specifically, when it is a request for rotation start of the reel, the CPU 31 starts to rotate the reels 3L, 3C, 3R and carries out the rotation at a constant speed. When the expected stop position is determined, the CPU waits until the symbol counter of the corresponding reel is updated to the same value as the expected stop position, and then stops the rotation of the corresponding reel. For example, if the symbol counter is “19” and the expected stop position is “0”, the CPU stops the rotation of the reel when symbol counter is updated to “0”.

Next, the CPU 31 performs a lamp and 7SEG driving process (step S164). Specifically, the CPU 31 turns on the BET lamps 9a, 9b, 9c in accordance with the insertion number counter and displays the payout number relating to the winning establishment on the information display unit 18.

Next, the CPU 31 carries out a restore of the register (step S165). Meanwhile, it may be performed a process of subtracting 1 from the above mentioned automatic stop timer in the intervention process having a period of 1.1173 ms. When this process is terminated, the CPU terminates the intervention process having a period of 1.1173 ms.

In the followings, it will be described a control operation of the sun-control circuit 72, with reference to the flow charts of FIGS. 28 to 30.

First, description is made to a RESET intervention process performed in the sub-control circuit 72, referring to FIG. 28. The sub CPU of the sub control circuit 72 generates a reset intervention in response to power supply and voltage application to the reset terminal, and based on the generation of the intervention, sequentially performs a reset intervention process stored in the sub ROM.

First, the sub CPU performs the initialization for example of a register or a sub RAM (step S201). Then, the sub CPU performs a receiving process for a command as will be explained later with reference to FIG. 29. The command receiving process determines an effect data that is executed by the liquid crystal display device 5, the LED 101, the lamp 102 or speakers S1L and 21R according to the type of the received command.

Then, the sub CPU performs a command output process (step S203). This command output process is for controlling the liquid crystal display device 5, the LED 101, the lamp 102 or the speakers S1L and 21R based on the effect data as determined above, and performs an output process of the effect data. Upon completion of the command output process, the sub CPU performs S202.

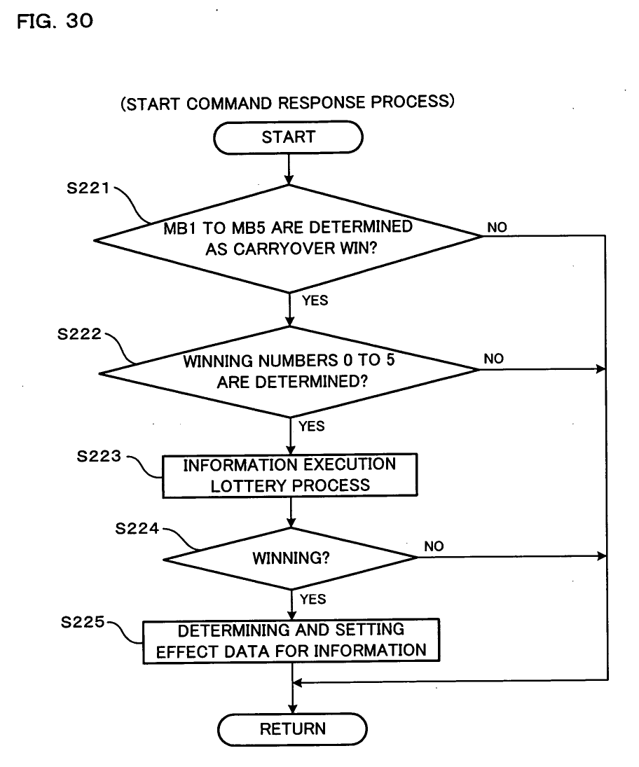

Next, referring to FIG. 29, the command receiving process will be described. First, the sub CPU determines whether or not a command is received from the main control circuit 71 (step S211). If it is determined that the command is not received, the sub CPU terminates the command receiving process, and performs S203 in FIG. 28. If it is determined that the command is received, the sub CPU performs a command response process (step S212). The command response process includes a start command response process as will be described later with reference to FIG. 30.

Next, it will be described of a start command response process that is performed in response to the start command received from the main control circuit 71, with reference to FIG. 30.

First, the sub CPU acquires carryover win data from the start command, and determines which one of MB1 to MB5 is determined as a carryover win (step S221). If any one of MB1 to MB5 is not determined as the carryover win, the CPU 31 terminates the start command response process and performs S203 in FIG. 28.

If one of MB1 to MB5 is determined as the carryover win, the sub CPU acquires winning number data from the start command, and determines which one of winning numbers 0 to 5 is determined (step S222). If any one of the winning numbers 0 to 5 is not determined, the CPU 31 terminates the start command response process, and performs S203 in FIG. 28.

If it is determined that one of the winning numbers 0 to 5 is determined, the sub CPU performs an information execution lottery process (step S223). This process is to determine whether or not a random number sampled from a predetermined range (e.g., “0 to 255”) belongs to a winning range (e.g., “0 to 63”).

Then, the sub CPU determines whether or not a player has won the information execution lottery (step S224). If determined that the player has lost the lottery, the sub CPU terminates the start command response process, and performs S203 in FIG. 28.

If it is determined that the player has won the lottery (step S224), the sub CPU determines effect data for information and performs setting it (step S225). Upon completion of this process, the sub CPU terminates the start command response process and performs S203 in FIG. 28. When the effect data for information is determined, in the above-mentioned command output process of S203, the sub CPU outputs the effect data for information, for example, by displaying a specific image via the liquid crystal display device 5.

In the gaming machine 1 according to this embodiment of the invention as described above, if MB is determined as the internal win, an internal lottery table for the base game mode is converted into an internal lottery table for carryover during the carryover of MB, and the internal win is determined based on the internal lottery table for corresponding carryover. The internal lottery table for carryover has a very higher winning probability for winning numbers 6 to 15 (red Replay 1 to blue Replay 5) compared to the internal lottery table for the base game mode. That is, when MB is carried over, it is possible to raise the probability of determining Replay higher over a situation that MB is not carried over.

The gaming machine 1 of this embodiment stops the rotation of the reel based on the internal win determined in this unit game and the carried-over internal win (i.e., based on data stored in an internal win storing area) and on the priority ranking table. In the priority ranking table, priority defined in Replay is higher than that defined in MB. That is, where MB and Replay are determined as the internal win, the combination of symbols according to Replay can be displayed with priority on an activated line.

In the internal lottery table for the base game mode, there is defined a specific random number range overlapped by a range of random numbers where MB is determined overlaps and that where Replay is determined. That is, when a random number is sampled from the overlapping random number range, it is possible to determine both MB and Replay. Since it is highly probable that Replay can be determined also in a unit game where MB is determined (so-called an internally winning game), it is possible to prevent the combination of symbols according to MB from being displayed apparent. As a result, in the internally winning game of MB, since it is possible to avoid the combination of symbols according to MB from being displayed apparent on an activated line as much as possible, it is possible to prevent the player from being stripped of a chance to raise the expectation for MB by guessing whether or not MB has been won. Especially, in this embodiment where symbols according to MB are attracted in even at a stop starting position, the combination of symbols according to MB is displayed in the internally winning game, and thus becomes more appropriate.

Even if Replay is determined during the carryover of MB, it is possible to prevent the combination of symbols according to MB from being displayed apparent. Since the chance to determine Replay is raised with carryover of MB as mentioned above, it becomes possible to prolong the period from the determination of MB to the start-up of MB as well as to increase the frequency to display the combination of symbols according to Replay. Accordingly, it is possible to provide a player with more chances to guess at winning, thereby making the player keep expectation to win. This as a result allows the player to guess at the determination of a desired internal win through expectation or reasoning, thereby making the player more attracted to the game.

Furthermore, in the gaming machine 1 of this embodiment, MBs (i.e., MB1 to MB5) are defined in an internal lottery table for the base game mode, and Replays (i.e., red Replay 1 to red Replay 5 and blue Replay 1 to blue Replay 5) are defined in an internal lottery table for the base game mode and an internal lottery table for carryover. There are installed internal lottery tables according to MB types (i.e., an internal lottery table for MB1 carryover, an internal lottery table for MB2 or MB3 carryover and an internal lottery table for MB4 or MB5). In the tables, Replays of a predetermined type have different winning probabilities. Therefore, when a player observes the frequency of displaying the combination of symbols according to the predetermined type of Replay, he/she can expect the type of carried-over MB. This can raise the pleasure of expectation, thereby making the player more attracted to the game.

For example, the internal lottery table for MB4 or MB5 carryover has the highest winning probability for the overall red Replays as described above. The internal lottery table for MB2 or MB3 carryover has the second highest winning probability, but the internal lottery table for MB1 carryover has the lowest winning probability. For the overall blue Replays, the internal lottery table for MB1 carryover has the highest winning probability and the internal lottery table for MB2 or MB3 carryover has the second highest winning probability, but the internal lottery table for MB4 or MB5 carryover has the lowest winning probability. Like this, the player can expect the type of a carried-over MB by observing the types of red Replays or blue Replays.

In the internal lottery table, for example, there is a difference between the winning probability for the overall red Replays and that for the overall blue Replays, and the winning probability for the overall blue Replays is higher than that for the overall red Replays. Furthermore, in each internal lottery table for carryover, the winning probability for the overall red Replays is different from that for the blue Replays. Specifically, the winning probability ratios are “3652:45500” in the internal lottery table for MB1 carryover, “8802:40350” in the internal lottery table for MB2 or MB3 carryover, and “19152:30000” in the internal lottery table for MB4 or MB5. The winning probability ratio is “980:8000” in the internal lottery table for the base game mode. Therefore, the player can observe the frequency of displaying the combination of symbols according to red Replays with respect to that according to blue Replays in order to expect the type of a carried-over MB. That is, when the player feels that the combination of symbols according to red Replays is higher than that according to blue Replays, he/she can expect that MB4 or MB5 might have been determined. Furthermore, when the frequency of displaying the combination of symbols according to red Replays is lower than that according to blue Replays, the player can expect that MB1 might has been determined.

As described above, red Replays (or blue Replays) have different winning probabilities according to the internal lottery tables for carryover. For example, the winning probability for red Replay 4 is highest in the internal lottery table for MB4 or MB5 carryover, and second highest in that for MB1 carryover, but lowest in that for MB2 or MB3 carryover. The winning probability for blue Replay 1 is highest in the internal lottery table for MB2 or MB3 carryover, and second highest in that for MB4 or MB5 carryover, but lowest in that for MB1 carryover. Like this, the player can expect the type of a carried-over MB by observing the types of each Replay.

Furthermore, MB and Replay are determined in the internal lottery tables for the base game mode, but different Replay types are determined together with MB types. For example, MB1 is determined together with red Replay 4 or blue Replay 1, and MB2 is determined together with red Replay 1 or blue Replay 4. Accordingly, making the player guess or expect the type of determined MB is not limited to a situation where MB is carried over, but can be realized even in an internally winning game of MB.

Furthermore, according to a symbol arrangement along the periphery of the reels 3L, 3C and 3R of this embodiment, each of 7, red flowers, yellow flowers and blue flowers can be attracted into the center line 8c within the range of 4 symbols. That is, since the combination of symbols according to a determined internal win is positively displayed on the activated line regardless of the skill of the player, it is possible to alleviate any load according to the stop operation by the player. In particular, where MB is determined, the combination of symbols according to MB is positively displayed in an internally winning game of MB. In this embodiment, since the rotation of the reel is stopped according to the priority ranking table, if Replay is determined, the combination of symbols according to MB is not displayed even if MB is determined. That is, the combination of symbols according to MB is displayed only in a situation that the internal win other than Replay, for example a small win or losing, is determined. According to the afore-mentioned construction, when the player meets a chance, the combination of symbols according to MB can be positively displayed. Therefore, since the combination of symbols according to MB is displayed regardless of the skill of the player, or the operation of MB is not delayed by a stop operation or erroneous operation by the player, it is possible to prevent the time period up to the operation of MB from being prolonged according to the skill of the player.

Further, in the gaming machine 1 of the present embodiment, when the rotation of all the reels 3L, 3C and 3R is stopped, the determination of whether the winning or the losing is made based on only a combination of the symbols displayed on the center line 8c of lines 8a through 8e provided on the display windows 4L, 4C and 4R. Thus, a target region by which whether the winning or the losing is determined is defined, so that an activated line which is intended to determine the winning and an inactivated line which is intended to determine the losing are provided. As a result, for example, as an internal win, the symbols attendant on the undetermined win can be displayed on the inactivated line.

In other words, in the gaming machine 1 of the present embodiment, when any combination of the symbols according to red Replay 2-5 (or blue Replay 2-5) except red Replay 1 (or blue Replay 1) is displayed on the center line 8c, a combination of the symbols according to red Replay 1 (or blue Replay 1) is displayed on any line according to types of red Replay 2-5 (or blue Replay 2-5), as any other line than the center line 8c (i.e. the top line 8b, bottom line 8d, cross-up line 8a, or cross-down line 8e). Therefore, the combination of the symbols according to red Replay 1 (or blue Replay 1) is displayed on any other line than the center line 8c, so that it is possible to show the player as if a win is determined, and thereby improve the interest of the gaming.

For example, when a combination of the symbols according to red Replay 2, “yellow flower-blue flower-7”, is displayed on the center line 8c, a combination of the symbols according to red Replay 1, “red flower-red flower-red flower”, is displayed on the top line 8b. When a combination of the symbols according to blue Replay 2, “7-7-yellow flower”, is displayed on the center line 8c, a combination of the symbols according to blue Replay 1, “blue flower-blue flower-blue flower”, is displayed on the top line 8b.

Because of the symbol combination made up of each different type of symbol as in the combination of the symbols according to red Replay2, “yellow flower-blue flower-7”, the player may have difficulty in discriminating the symbol combination attendant on the win at first sight. However, because the symbol combination “red flower-red flower-red flower” made up of the symbols of the same type is displayed on a different line, visibility is improved, and it is easy of the player to recognize whether or not a win is determined at first sight. Further, it is possible to infer which type of Replay is established by the type of the line on which the combination of the symbols of the same type is displayed. As a result, the type of each Replay is easily discriminated, so that it is possible to reduce a load when the type of the determined MB is predicted or inferred.

Further, in the gaming machine 1 of the present embodiment, because whether the winning or the losing is determined based on only the combination of the symbols displayed on one activated line, it is possible to lighten a burden on management required to determine either winning or losing with respect to the other lines, compared to the conventional gaming machine having the activated lines. Thus, it is possible to make the management rapid in connection with the determination of whether the winning or the losing, compared to the conventional gaming machine.

Also, in the present embodiment, one line is set as the activated line in both the base game mode and the CB game mode, so that it is possible to make the management common in connection with the determination of whether the winning or the losing. Hence, it is not necessary to change the activated line according to the game mode as in the conventional gaming machine having the activated lines, and thereby it is possible to inhibit increase in program capacity to the maximum extent.

Meanwhile, a detailed construction of the reel, a symbol display unit, a start operation detection unit, a random number sampling unit, internal lottery table memory, an internal win determination unit, a reel rotation unit, a stop operation detection unit, a reel stop unit, a symbol combination determination unit, a re-gaming unit, an advantageous mode operation unit, a carry-over unit, a priority ranking table memory, or so on which is included in the gaming machine according to the present invention may be arbitrarily modified without being limited to each element of the present embodiment as mentioned above.

In addition to the above-mentioned components, the gaming machine further has a sliding display number determination unit, which performs processing of step S122 of FIG. 23 which is performed by the CPU 31, for determining, when the stop operation is detected by the stop operation detection unit, a sliding display number (e.g. a number of the symbols passing through a predetermined position until the rotation of the reel makes a stop after the stop operation is detected by the stop operation detection unit) among from a number less than a predetermined maximum sliding display number (e.g. 4 symbols described above), and a reel stop unit for stopping the rotation of a corresponding reel based on the sliding display number determined by the sliding display number determination unit, wherein the sliding display number determination unit may additionally include a component determined among from the number less than a specified maximum sliding display number (e.g. 1 symbol described above) less than the predetermined maximum sliding display number when the game mode advantageous to the player is operated by the advantageous mode operation unit.

The above-described embodiment is so constructed that the player has the same degree of advantage in each of specified internal win, but it is not limited to this construction. Therefore, the player may have a different degree of advantage according to types of the specified internal wins. In other words, the above-described embodiment is so constructed that the same value (i.e. 253) is stored in the bonus end number counters regardless of the type of the MB when the MB operates, but it is not limited to this construction. Therefore, a different value may be stored in each bonus end number counter according the type of the MB. Thereby, because the number of medals which the player can obtain according the type of the MB is varied, the player can be varied in the degree of advantage. As a result, a degree of expectation which the player have according the type of the MB can be varied, so that it is possible to improve the interest of the gaming.

The above-described embodiment applies 1 symbol as the maximum number of sliding symbols in the CB game mode, but it is not limited to this construction. Therefore, 0 symbol may be applied. The technical intervention of the player can be enhanced.

The above-described embodiment is so constructed that what causes the number of sliding symbols in the CB game mode to be determined among from the number less than 1 symbol is adopted as the left reel 3L, but it is not limited to this construction. Therefore, the other reels 3C and 3R may be applied.

The above-described embodiment is so constructed that what causes the number of sliding symbols in the CB game mode to be determined among from the number less than 1 symbol is adopted as one reel, and the rest is adapted to be determined among from the number less than 4 symbols, but it is not limited to this construction. Therefore, the number of reels determined among from the number less than 1 symbol may be arbitrarily applied. As the number of applied reels increases, the technical intervention of the player can be enhanced.

The above-described embodiment is so constructed that the CB game mode is applied as the game mode advantageous to the player, and the MB is applied as the specified win depending on the operation of the game mode advantageous to the player, but it is not limited to this construction. Therefore, either the type of the game mode advantageous to the player or the type of the specified win depending on the operation of the game mode advantageous to the player may be arbitrarily applied. As the game mode advantageous to the player, for instance the so-called regular bonus (RB) or big bonus (BB) is applied. When the operation of the game mode advantageous to the player is carried out, the internal win may be determined on the basis of the special internal lottery table of which the random number by which the internal win (e.g. the small win) depending on the payout of the gaming medium such as the medal is determined has a greater range than the other internal lottery table. Thereby, a chance that the payout of the gaming medium is performed can be increased, and the expectation of the player can be improved.

The above-described embodiment is so constructed that, when the internal win except the Replays (i.e. the small win having the priority lower than the MB, or the lost lot) in a condition where the MB is carried over, the effect for information is adapted to be performed at a predetermined probability (See FIG. 30), and the player is adapted to infer the timing at which the combination of the symbols attendant on the MB can be displayed, but it is not limited to this construction. Therefore, the corresponding effect for information may not be performed.

The above-described embodiment is so constructed that the center line 8c is applied as a predetermined one line, but it is not limited to this construction. Therefore, the other lines may be applied. For example, any one of the top line 8b, bottom line 8d, cross-up line 8a, and cross-down line 8e may be applied. Further, the region connecting the top of the left display window 4L, the middle of the center display window 4C, and the top of the right display window 4R may be applied by way of example, without being limited to what is applied in the present embodiment.

The above-described embodiment is so constructed that the three display windows 4L, 4C and 4R corresponding to the reels 3L, 3C and 3R respectively are provided, but it is not limited to this construction. For example, only one display window may be formed. In other words, the display window will do if some symbols (e.g. three symbols) of symbols arranged on the periphery of each reel 3L, 3C and 3R can be displayed.

The above-described embodiment is so constructed that the rotation of the reels is adapted to be stopped based on the stop table and the internal win and priority ranking table, but it is not limited to this construction. Therefore, the rotation of the reels may be stopped based on the-internal win and priority ranking table without installing the stop table.

The constructions of the apparatuses illustrated in FIGS. 1 and 2, the circuit and its peripherals illustrated in FIG. 3, the tables illustrated in FIGS. 4 through 14, the storing regions of the RAMs illustrated in FIGS. 15 through 17, and the flow charts illustrated in FIGS. 18 through 30 which are applied in the above-embodiment, and so on can be arbitrarily modified and changed without departing from the idea of the present invention.

The present invention may be applied to a gaming machine such as a slot machine, a video slot, etc. except the pachi-slot machine as in the above-mentioned embodiment. Further, the present invention may be applied to a game program executing operation of the above-mentioned slot machine for a household gaming machine in a pseudo way, and thereby the game can be executed. In this case, recorded media recording the game program may make use of CD-ROM, Flexible Disk (FD), and any other recordable media.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a plurality of reels, each of which having a plurality of symbols arranged on a periphery thereof;
a symbol display unit for displaying part of the symbols among those arranged on the periphery of the respective reels;
a start operation detection unit for detecting a start operation;
a random number sampling unit for sampling a random number based on the detection of the start operation by the start operation detecting unit;
an internal lottery table memory for storing an internal lottery table defining the range of the random number determining an internal win;
an internal win determining unit for determining an internal win on the basis of the random number sampled by the random number sampling unit and the internal lottery table stored in the internal lottery table memory;
a reel rotation unit for rotating the respective reels if the start operation is detected by the start operation detection unit;
a stop operation detection unit for detecting a stop operation according to a type of the reels;
a reel stop unit for stopping rotation of a corresponding reel when the stop operation is detected by the stop operation detection unit;
a symbol combination determination unit for determining a combination of the symbols displayed by the symbol display unit if rotation of the reels stops;
a re-gaming unit for performing a replay if the symbol combination determination unit determines that the combination of the symbols according to the replay has been displayed;
an advantageous mode operation unit for performing an operation of a game mode advantageous to a player if the symbol combination determination unit determines that a combination of the symbols according to the operation of the advantageous game mode has been displayed;
a carryover unit, if the internal win determination unit determines a specified internal win according to the operation of the advantageous game mode, for carrying over the specified internal win; and
a priority ranking table memory for storing a priority ranking table defining a priority rank according to the internal win,
wherein if the specified internal win is determined based on a predetermined internal lottery table, the internal win determination unit determines an internal win based on a specified internal lottery table having larger range of the random number determining the internal win of the replay than that of the predetermined internal lottery table,
wherein the priority ranking table is defined such that the internal win of the replay has higher priority than that of the specified internal win, and
wherein if the stop operation is detected by the stop operation detection unit, the reel stop unit stops rotation of a corresponding reel, based on the internal win determined by the internal win determination unit, the specified internal win carried over by the carryover unit, and the priority ranking table.

2. A gaming machine comprising:
a plurality of reels, each of which having a plurality of symbols arranged on a periphery thereof;
a symbol display unit for displaying part of the symbols among those arranged on the periphery of the respective reels;
a start operation detection unit for detecting a start operation;
a random number sampling unit for sampling a random number based on the detection of the start operation by the start operation detecting unit;
an internal lottery table memory for storing an internal lottery table defining the range of the random number determining an internal win;
an internal win determining unit for determining an internal win on the basis of the random number sampled by the random number sampling unit and the internal lottery table stored in the internal lottery table memory;
a reel rotation unit for rotating the respective reels if the start operation is detected by the start operation detection unit;
a stop operation detection unit for detecting a stop operation according to a type of the reels;
a reel stop unit for stopping rotation of a corresponding reel when the stop operation is detected by the stop operation detection unit;
a symbol combination determination unit for determining a combination of the symbols displayed by the symbol display unit if rotation of the reels stops;
a re-gaming unit for performing a replay if the symbol combination determination unit determines that the combination of the symbols according to the replay has been displayed;
an advantageous mode operation unit for performing an operation of a game mode advantageous to a player if the symbol combination determination unit determines that a combination of the symbols according to the operation of the advantageous game mode has been displayed;
a carryover unit, if the internal win determination unit determines a specified internal win according to the operation of the advantageous game mode, for carrying over the specified internal win; and
a priority ranking table memory for storing a priority ranking table defining a priority rank according to the internal win,
wherein the internal lottery table memory stores a predetermined internal lottery table defining the range of the random number determining the specified internal win together with the internal win of the replay,
wherein if the specified internal win is carried over by the carryover unit, the internal win determination unit determines an internal win based on a specified internal lottery table having larger range of the random number determining the internal win of the replay than that of the predetermined internal lottery table,
wherein the priority ranking table is defined such that the internal win of the replay has higher priority than that of the specified internal win, and wherein if the stop operation is detected by the stop operation detection unit, the reel stop unit stops rotation of a corresponding reel, based on the internal win determined by the internal win determination unit, the specified internal win carried over by the carryover unit, and the priority ranking table.

3. The gaming machine according to claim 1, wherein the predetermined internal lottery table is defined with random numbers that determine the specified internal win,
wherein the predetermined internal lottery table and the specified internal lottery table are defined with random numbers that determine an internal win of the replay,
wherein the internal lottery table memory memories a plurality of specified internal lottery tables in which the magnitudes of the random number that determines an internal win of the replay of a predetermined type are different from each other according to the type of the specified internal win, and
wherein the internal win determination unit determines an internal win based on the specified internal lottery table according to the type of the specified internal win.

4. The gaming machine according to claim 1, wherein the symbol display unit installs a plurality of areas each displaying one of the symbols at each of the reels, thereby displaying part of the symbols among the symbols arranged on the periphery of the respective reels,
wherein the symbol combination determination unit determines a combination of the symbols displayed on one predetermined line among a plurality of lines formed by respectively connecting any one of the areas installed on each of the reels when the rotation of the reels makes a stop, and
wherein when a predetermined symbol combination is displayed on the one line, other than a specified symbol combination among combinations of the symbols according to the types of the internal win of the replay, symbols constituting the predetermined symbol combination and symbols constituting the specified symbol combination are respectively arranged on the periphery of the reels, so that the specified symbol combination is displayed on a line, which is different from the one line and is according to the types of the internal win of the replay.
